(19) United States
(12) Patent Application Publication
(10) Pub. No.: US 2026/0367879 A1
(43) Pub. Date: Nov. 19, 2026

(54) BILINEAR PAIRINGS

(71) Applicant: nChain Licensing AG, Zug (CH)

(72) Inventors: Paul GERMOUTY, London (GB); Enrique LARRAIA, London (GB); Wei ZHANG, London (GB)

(21) Appl. No.: 19/496,886

(22) PCT Filed: May 29, 2024
(86) PCT No.: PCT/EP2024/064810

§ 371 Date: Dec. 23, 2025

(30) Foreign Application Priority Data
Jun. 29, 2023 (GB) 2309896.5

(51) Int. Cl. G06F 8/30; G06F 8/41

(52) U.S. Cl. CPC G06F 8/315; G06F 8/452

(57) ABSTRACT

A computer-implemented method for computing a pairing in script is provided. A script is generated which is configured to execute a line function and a square-and-update function. The line function computes an array of elements. The array of elements is provided as an input to the square-and-update function. The square-and-update function computes an intermediate value for computing a pairing.

### CROSS REFERENCE TO RELATED APPLICATIONS

This application is the U.S. National Stage of International Application No. PCT/EP2024/064810 filed on May 29, 2024, which claims the benefit of United Kingdom Patent Application No. 2309896.5, filed on Jun. 29, 2023, the contents of which are all incorporated herein by reference in their entireties.

### TECHNICAL FIELD

The present disclosure relates to a computer-implemented method for computing a pairing in script.

### BACKGROUND

Pairings over elliptic curves span a large number of cryptographic applications. For example, with pairings it is possible to construct signatures, identity-based encryption, non-interactive zero-knowledge proofs, and communication-efficient multi-party key agreement.

A pairing e is a bilinear map defined over two group source elements, [symbol] ₁, [symbol] ₂ in a torsion group E( [symbol] ₚ_{^{k}})[r]. It maps a pair of elements to an element in a target group

$${𝔾}_{T} := {𝔽}_{{p}^{k}}^{*} :$$

e: [symbol] ₁× [symbol] ₂→ [symbol] _{T}.

### SUMMARY

Efficiently implementing a pairing in script is not trivial. Methods known in the art require script sizes of around 1.5 MB. Provided herein are methods for improving the computational efficiency of a pairing computation, and thereby optimising a resultant pairing script.

An important part of the pairing computation is the execution of a Miller loop or Miller function. The Miller function can be written as two functions, with the second taking as input the output of the first. The output of the Miller function is an intermediate value, which can be used to compute the pairing. The Miller function split in this way allows for a more efficient algorithm, and therefore reduces the computations.

According to one aspect disclosed herein, there is provided a computer-implemented method for computing a pairing in script, the method comprising generating a script configured to: execute a line function to compute an array of elements; and execute a square-and-update function, wherein the array of elements is provided as an input to the square-and-update function, to compute an intermediate value for computing a pairing.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 illustrates point addition and point doubling in an elliptic curve,

FIG. 4 schematically illustrates a conceptual division of scripts for computing a pairing,

FIG. 5 schematically illustrates dependencies of scripts implemented extension field arithmetic, and

FIG. 6 schematically illustrates relationships of scripts for implementing a Miller loop for computing a sing pairing or a multi-pairing.

### DETAILED DESCRIPTION OF EMBODIMENTS

### 1. Elliptical Curves and Pairings

### 1.1 Elliptic Curves

Let a cubic equation y²=x³+ax+b where the coefficients a, b are taken from a finite field [symbol] _{q} of q elements. An elliptic curve is the set of affine points P:=(x,y) that satisfy the above equation along with an extra point at infinity denoted with [symbol] :

E| [symbol] _{q}:={P:=(x,y)|y²=x³+ax+b}∪{ [symbol] }.

[symbol] _{q} is the field of definition of the curve, that is, a, b∈ [symbol] _{q}, and it can be said that E is over [symbol] _{q}. The coordinates x,y of points P∈E| [symbol] _{q} do not necessarily lie in [symbol] _{q}, they can be defined over an extension field [symbol] _{q}_{^{k}} (of q^{k} elements).

Notation. The notation E| [symbol] _{q}: y²=x³+ax+b means an elliptic curve over [symbol] _{q} with equation y²=x³+ax+b. E: y² x³+ax+b is written if the field of definition is understood from context but there is a want to stress which is the cubic equation. E can be written if both the field of definition and the equation are understood from context; it denotes all points in the elliptic curve (that is, points P:=(x,y) with coordinates x, y in any possible extension field). E( [symbol] _{q}) denotes the set of points whose coordinates are in [symbol] _{q}. Likewise, E( [symbol] _{q}_{^{k}}) denotes the set of points with coordinates in the extension [symbol] _{q}_{^{k}}.

### 1.1.1 Adding and Doubling Points in Affine Coordinates

An elliptic curve E forms a group under the ‘tangent and chord’ rule. This addition rule makes E a group with identity element the point at infinity [symbol] .

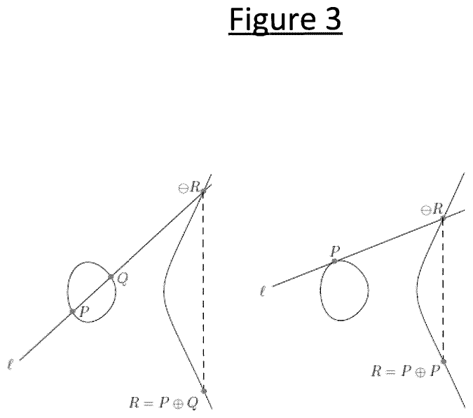

FIG. 3 illustrates group law in elliptic curve. The left-hand graph illustrates point addition, while the right-hand graph illustrates point doubling.

To add two points P≠Q the line [symbol] _{P,Q} passing through P,Q and the vertical line ν_{R} passing through the intersection point with E that is not P or Q (i.e., −R in FIG. 3, left) are needed. Likewise, to double a point P, the tangent line [symbol] _{P,P} of E at P and the vertical line ν_{R} passing through the other intersection point with E (−R in FIG. 3, right) are needed. The formulas are given below, with the left-had formulas corresponding to point addition for P≠Q, and the right-hand formulas corresponding to point doubling for P+P:=2P.

| | |
|---|---|
| $λ := \frac{{y}_{P} - {x}_{P}}{{x}_{Q} - {x}_{P}}$ | $λ := \frac{3 {x}_{P}^{2}}{2 {y}_{P}}$ |
| If P ≠ Q then P + Q := (x_{R}, y_{R}) have coordinates: | P + P := (x_{R}, y_{R}) have coordinates: |
| ${x}_{R} := {λ}^{2} - {x}_{P} - {x}_{Q} = {( \frac{{y}_{P} - {x}_{P}}{{x}_{Q} - {x}_{P}} )}^{2} - {x}_{P} - {x}_{Q}$ | ${x}_{R} := {λ}^{2} - 2 {x}_{P} = {( \frac{{y}_{P} - {x}_{P}}{{x}_{Q} - {x}_{P}} )}^{2} - 2 {x}_{P}$ |
| ${y}_{R} := λ ( {x}_{P} - {x}_{R} ) - {y}_{P} := \frac{{y}_{P} - {x}_{P}}{{x}_{Q} - {x}_{P}} ( {x}_{P} - {x}_{R} ) - {y}_{P}$ | ${y}_{R} := λ ( {x}_{P} - {x}_{R} ) := \frac{- {y}_{P} {y}_{P} - {x}_{P}}{{x}_{Q} - {x}_{P}} ( {x}_{P} - {x}_{R} ) - {y}_{P}$ |

Note 1. As is shown in section 1.8, the line g_{P,Q} passing through P≠Q, the tangent line g_{P,P} at P, and the vertical line ν_{R} at R play an important role in the definition of a pairing. The formulas are given in the table below, which provide the evaluation of ‘tangent-and-chord’ lines at an arbitrary point S of E in affine coordinates.

```
Evaluation of line g_{P,Q} passing through P := (x_{P}, y_{P}) ≠ Q :=
(x_{Q}, y_{Q}) at point S = (x, y):
    $\begin{matrix}{g}_{P , Q} ( x , y ) := y - ( λ x + {y}_{P} - λ {x}_{P} ) := \\ y - ( \frac{{y}_{P} - {x}_{P}}{{x}_{Q} - {x}_{P}} x + {y}_{P} - \frac{{y}_{P} - {x}_{P}}{{x}_{Q} - {x}_{P}} {x}_{P} )\end{matrix}$
Evaluation of tangent line g_{p,p} (S) at point S := (x, y)
      ${g}_{P , P} ( x , y ) := y - ( λ x + {y}_{P} - λ {x}_{P} ) := y - ( \frac{3 {x}_{P}^{2}}{2 {y}_{P}} x + {y}_{P} - \frac{3 {x}_{P}^{2}}{2 {y}_{P}} {x}_{P} )$
Evaluation of vertical line passing through P at point S := (x, y)
          vₚ(x, y) := x − x_{P}
```

### 1.1.2 Multiplying Points by a Scalar

Let any integer m∈ [symbol] , and a point P, the scalar multiplication [m]P is defined by adding m times P to itself (or adding −P in case m is negative.)

[m]P:=P+ . . . +P.
m times

### 1.2 Projective Coordinates

Point addition as described in the above section requires inverting field elements (either x_{Q}−x_{P} or 2y_{P}) to compute the scalar λ. Inverting is an expensive operation and therefore it is desirable to avoid it. This can be achieved switching to projective coordinates. The change of coordinates

$$x = \frac{X}{Z} , y = \frac{Y}{Z}$$

allows for working with points P:=(X,Y,Z) and rewriting the formulas for elliptic curve arithmetic of FIG. 3 without inverting field elements.
1.3 The torsion Group E[r] and the Embedding Degree

Let n=#E be the order (size) of the elliptic curve. Then, it holds that [n]P= [symbol] for every P∈E. However, points may vanish for smaller scalars. For any divisor r of n, the r-torsion group is the set of points of order r:

E[r]:={P∈E|[r]P= [symbol] }.

The r-torsion also forms a group. It is therefore a subgroup of E. The structure of the r-torsion group is well known. If r is prime to q, then E[r]≅ [symbol] ᵣ× [symbol] Zᵣ. This means that #E[r]=r² and it has r+1 cyclic subgroups of order r.

### 1.3.1 The Embedding Degree of a Curve E

Recall from Section 1.1 that (the coordinates of) points of an elliptic curve E lie in an extension field [symbol] _{q}_{^{k}} of the field of definition [symbol] _{q}. This also means that torsion points might are in an extension field. The embedding degree k tells where the entire torsion group E[r] lies. The following two equivalent conditions define k:
k is the smallest positive integer such that r divides q^{k}−1.
k is the smallest positive integer such that E[r]⊂E( [symbol] _{q}_{^{k}}).

Cleary, by definition, the embedding degree depends on q and r. Thus, for any choice of q, r it can be seen that the corresponding embedding degree is k(q,r).

### 1.3.2 Two Subgroups of E[r]

Pairings over E can be defined over any two subgroups of E[r]. For efficiency reasons, type-3 pairings (see Section 1.5.1) are defined over the following two subgroups of the r-torsion.

1.3.3 The Base-Field Group [symbol] ₁≤E[r]

This is the only subgroup of E[r] that lies entirely in E( [symbol] _{q}). The base-field group [symbol] ₁ is defined as the r-torsion elements in the eigenspace of the Frobenius map π: E→E, (x,y) [symbol] (x^{q}, y^{q}). Thus:

[symbol]

₁:=E( [symbol] _{q}_{^{k}})[r]Ωker(π−[1]).

Since π fixes a point P∈E( [symbol] _{q}_{^{k}}), namely P=π(P), if and only if P∈E( [symbol] _{q}), then [symbol] ₁=E( [symbol] _{q})[r]. This group is sometimes called the group of rational points of order r.

Note 2. What is important to remember is that coordinates of points in [symbol] ₁ are always in [symbol] _{q}, and hence elliptic-curve arithmetic in [symbol] ₁ is as efficient as possible.

1.3.4 The Zero-Trace Group [symbol] ₂≤E[r]

This is a subgroup of E[r] with an important property. Any point of the torsion group can be mapped to a point in [symbol] ₂. That is, there exists an explicit (computable) homomorphism aTr, such that for all P∈E[r], aTr(P)∈ [symbol] ₂.

The trace map is defined as

$$Tr ( P ) := {Σ}_{i = 0}^{k - 1} ( {x}^{{q}^{i}} , {y}^{{q}^{i}} ) ,$$

where P:=(x,y). The trace map actually maps any point in E into E( [symbol] _{q}). The zero-trace elements are points that are mapped to [symbol] . Thus, [symbol] ₂ is the eigenspace:

[symbol]

₂:=E( [symbol] _{q}_{^{k}})[r]∩ker(Tr−[q]).

The aTr map mentioned above is the anti-trace map defined as aTr(P):=[k]P−Tr(P). It holds that Tr(aTr(P))= [symbol] , and therefore aTr maps points to [symbol] ₂.

Note 3. Performing arithmetic in [symbol] ₂ is expensive because points P,Q∈ [symbol] ₂ have coordinates in [symbol] _{q}_{^{k}}. It is not essential to work with [symbol] _{q}_{^{k}} directly, but instead with a smaller field [symbol] _{q}_{^{k/d}} using the twist of the curve (see Section 1.4.)

### 1.4 Twisted Curves

Let a curve E/ [symbol] _{q}: y²=x³+ax+b. The twist E′ is given by the equation:

E′| [symbol] _{q}_{^{k/d}}: y²=x³+aω⁴+bw⁶,

for some ω∈ [symbol] _{q}_{^{k}}. Note that E′ is defined over [symbol] _{q}_{^{k/d}}, where d is the degree of the twist. Both curves are isomorphic through Ψ: E′→E given by

$$Ψ ( {x}^{′} , {y}^{′} ) := ( \frac{{x}^{′}}{{ω}^{2}} , \frac{{y}^{′}}{{ω}^{3}} ) .$$

the possibilities d∈{2,3,4,6} is defined as follows:
Quadratic twists, d=2. They are available for any curve. E: y²=x³+ax+b. Thus, for any a, b E IFq.
Cubic twists d=3. They are available for curves E: y²=x³+b. Thus a=0.
Quartic twists. d=4. They are available for curves E: y²=x³+ax. Thus b=0.
Sextic twists d=6. They are available f or curves E: y²=x³+b. Thus a=0.

An important fact that will be used in the context of pairings is that the preimage under Ψ of the zero-trace group [symbol] ₂ in E| [symbol] _{q}_{^{k}} is the base-field group [symbol] ′₁ in the twist E′| [symbol] _{q}_{^{k}}_{/d}. That is, arithmetic in [symbol] ₂ can be done instead in its twist

$${𝔾}_{1}^{′}$$

and then the result mapped back to [symbol] ₂.

Note 4. Recall from Section 1.3 that arithmetic in [symbol] ₂ is expensive. What is important to remember is that if P+Q for P,Q∈ [symbol] 2 needs to be computed, R′:=Ψ⁻¹(P)+Ψ⁻¹(Q) can be computed and then use Ψ(R′)=P+Q whenever is needed in the Miller loop of the pairing computation (see Section 1.6). This improves efficiency because Ψ⁻¹(P), Ψ⁻¹(Q)∈

$${𝔾}_{1}^{′}$$

have coordinates in [symbol] _{q}_{^{k/d}} (instead of in the larger [symbol] _{q}_{^{k}}). A further improvement can be provided by avoiding the map Ψ⁻¹ by implicitly replacing [symbol] ₂ with its twist

$${𝔾}_{1}^{′}$$

when defining the domain of a pairing, perform point addition (or point doubling) with points P′, Q′∈ [symbol] ′₁, and then map the result to [symbol] ₂ via Ψ whenever the result is needed. Computing Ψ only requires two multiplications.

### 1.5 Pairings

A pairing e is a bilinear map defined over two group source elements [symbol] ₁, [symbol] ₂ in the torsion group E( [symbol] ₚ_{^{k}})[r]. It maps a pair of elements to an element in the target group

$${𝔾}_{T} := {𝔽}_{{p}^{k}}^{*} :$$

e: [symbol] ₁× [symbol] ₂× [symbol] _{T},
such that:
1. [symbol] or each (g₁, g₂)∈ [symbol] ₁× [symbol] ₂ and each (a,b)∈ [symbol] ²:

e(a·g₁,b·g₂)=e(g₁,g₂)^{ab}.
2. If (g₁, g₂) is a generator of [symbol] ₁× [symbol] ₂ then e(g₁, g₂) is a generator of [symbol] _{T}.
3. The pairing is efficiently computable.

### 1.5.1 Types of Pairings

Depending on how the source groups, [symbol] ₁, [symbol] ₂ are chosen there are three types of pairings.

Type 1. The symmetric pairing: [symbol] ₁= [symbol] ₂:=E( [symbol] _{q})[r], thus the base-field group (see Section 1.3). The curve must be supersingular, meaning there exists a distortion map φ that takes points in E( [symbol] _{q}) into E( [symbol] _{q}_{^{k}}). It is known how to hash into E( [symbol] _{q})[r] and sample random elements. All known pairings (see Section 1.3) require P and Q in different groups, so the pairing is defined as e(P,Q):=ê(P, φ(Q)). The drawback is that the condition E being supersingular hinders the efficiency of the pairing.

Type 2. [symbol] ₁:=( [symbol] _{q}) [r], the base-field group and ( [symbol] ₂≠ [symbol] T₁. In this setting the existence of an isomorphism from [symbol] ₂ on [symbol] ₁ is required, namely the trace map tr (see Section 1.3). This means that [symbol] ₂ cannot be the zero-trace group (because it is mapped to the identity element [symbol] via tr). The drawback is that it is not clear how to hash or sample random elements in [symbol] ₂, which restricts functionality. One benefit is that proving security is possible due to the efficient isomorphism tr.

Type 3. [symbol] ₁:=( [symbol] _{q})[r], the base-field group and [symbol] ₂:=φ⁻¹(E( [symbol] _{q}_{^{k}})[r]∩ke r(Tr−[q])), the preimage of the zero-trace group under the twist p. There is not known (efficient) isomorphism from [symbol] ₂ on [symbol] ₁, which affects security, but in this setting, it is clear how to hash and sample random elements in [symbol] ₂ (using the anti-trace map aTr).

Note 5. Nowadays, type 3 pairing is the one that is studied the most because it is more efficient than type 1 and gives more functionality than type 2. Therefore, type 3 pairings are used herein for Script implementation in Section 3.

### 1.6 Weil, Tate, and Optimal Ate Pairings

In layman words, pairing two points P,Q consists in constructing a function ƒ_{n,P} related to P and then evaluate it at point Q. The selected ƒ_{i,P} is a Miller function and it is defined as:

(ƒ_{n,p}):=n(P)−([n]P)−(n−|) [symbol] .

The above formula says that a Miller function ƒ_{n,P} has a zero at P with multiplicity n, a pole at [n]P, and a pole at [symbol] with multiplicity n−1.

The original pairing is due to Weil. Since then, several flavours have been proposed, with the optimal ate pairing the most efficient one. The different pairings can be defined succinctly as follows:

w(P,Q):=(−1)^{r}ƒ_{r,P}(Q)/ƒ_{r,Q}(P) Weil pairing:

τ(P,Q):=ƒ_{r,P}(Q)^{(q}^{^{k}}^{-1)/r}. Tate pairing:

aₒₚₜ(P,Q):=ƒ_{l,Q}(P)^{(a}^{^{k}}^{-1)/r}, for some [symbol] such that log( [symbol] )≈log(r)/φ. Optimal Ate pairing:
The Weil and Tate pairing require finding a function ƒ_{r,P}, which roughly has a degree of r, the order of the groups [symbol] ₁, [symbol] ₂, [symbol] _{T} For cryptographic applications, r is large, say 256 bits or more, and hence computing a function of degree ≈2²⁵⁶ is a huge task. In Section 1.7, it is shown how to compute this efficiently (i.e. in ≈log (r) steps).
The Weil pairing is typically not used because it requires computing two Miller functions (evaluated at P and at Q). The Tate pairing and the optimal Ate pairing require just one function evaluation (at P).
The optimal Ate pairing requires a Miller function of much lower degree [symbol] than the Tate pairing, and hence is more efficient to compute than the Tate pairing. For this reason, all known implementations use the optimal Ate pairing, as is also done herein. However, observe that the exponentiation to (q^{k}−1)/r does not change and the Miller function depends on Q (instead of P). In the type 3 setting, Q is a point in the twist of the zero-trace group, hence with coordinates in [symbol] _{q}_{^{k/d}}.

### 1.7 Pairing-Friendly Curves

An elliptic curve has parameters q, t, r, k:
q: A prime integer. The size of the underlying field [symbol] _{q}.
r: The size of the three groups [symbol] ₁, [symbol] ₂, [symbol] _{T}
k the embedding degree
t: The trace of Frobenius. (Needed for the optimal ate pairing only)

As the pairing entails performing arithmetic in [symbol] _{q}_{^{k}}, an elliptic curve is ‘pairing-friendly’ if the embedding degree k is not too large. Typically, k=6,12,24.

For cryptographic applications, it must be difficult to compute the elliptic-curve discrete logarithm (ECDLP) in the source groups [symbol] ₁, [symbol] ₂≤E( [symbol] _{q}_{^{k}})[r] of order r and the discrete logarithm problem (DLP) in the target group, namely the r-roots of unity

$${μ}_{r} \leq {𝔽}_{{q}^{k}}^{*}$$

for the optimal ate pairing. This imposes a trade-off between the size of q and the size of r,

The DLP in

$${𝔽}_{{q}^{k}}^{*}$$

is easier than ECDLP and the groups sizes are chosen accordingly to resist (EC)DLP solvers in all groups. The ratio between the size of

$${𝔽}_{{q}^{k}}^{*}$$

and [symbol] ᵢ is

$$\frac{log ( {q}^{k} )}{log ( r )} = \frac{k l o g ( q )}{log ( r )} : = k ρ .$$

The concrete value of this ratio is determined by the progress on solving these two problems. The parameter ρ measures how efficient arithmetic in the elliptic curve is. Ideally, one wants ρ=1.

Note 6. Larger values of ρ means working with a larger [symbol] _{q}. The focus herein is to minimize the number of instructions and not CPU cycles in the pairing computation. Thus, larger p are not necessarily a bad choice. Put differently, pairings over non-optimal curves might render scripts of smaller sizes. The embedding degree and the degree of the twist seem more important parameters in our context.

### 1.7.1 Parameterized Families

The values of q, r, t are parameterized as polynomials q(u), r(u), t(u). For a concrete value of u∈ [symbol] , values q, r, t can be obtained. Depending on the shape of the polynomials, there are different families.

The most famous families are BN, BLS12, BLS24 and KSS, although other families are possible. To achieve 128 bit of security BLS12 is preferred over BN given latest advances on solving DLP. Thus, the script implementation provided herein is based over this curve. BLS12 being a family, between BLS12-381 and BLS12-440. The former being more efficient but could suffer from improvements in solving DLP. The latter is less efficient (relatively, still type 3, see Note 5 above), but considered more secure: it seems unlikely that improvements in solving DLP will be seen in the near future to decrease its security below 128 bits. The table below describes the BLS12 curve family.

TABLE 1
Parametrisation of BLS12 curves.

BLS12 family: k = 12, ρ ≈ 1.5
$q ( u ) = \frac{{( u - 1 )}^{2} ( {u}^{4} - {u}^{2} + 1 )}{3} + u , r ( u ) = {u}^{4} - {u}^{2} + 1 , t ( u ) = u + 1$

### 1.8 Miller Algorithm

Recall from Section 1.6 that the optimal Ate pairing requires two steps, or functions. First compute ƒ:= [symbol] (P), then exponentiate ƒ^{(q}^{^{k}}^{-1)/r}. ƒ can be computed iteratively using the formulas:

$${f}_{0} = 1 ∈ {𝔽}_{{q}^{k}}$$

$${f}_{i + 1 , Q} : = {f}_{i , Q} \cdot \frac{{g}_{[ i ] Q , Q}}{{𝓋}_{[ i + 1 ] Q}}$$

$${f}_{2 i , Q} : = {f}_{i , Q}^{2} \cdot \frac{{ℊ}_{[ i ] Q , [ i ] Q}}{{𝓋}_{[ 2 i ] Q}}$$

Above, ƒ_{j,P} is the Miller function, g_{P,Q} is the line passing through points P,Q and ν_{P} the vertical line at P. Miller observed that the above gives raise to ‘double-and-add’ algorithm to compute ƒ_{r,Q} in roughly log (r) steps. To avoid storing ƒ_{r,Q} (which is a function of degree r), the intermediate functions ƒ_{i,Q} are evaluated at (the fixed) point P iteratively too.

TABLE 2
$Optimal Ate pairing in BLS . Point Q ∈ {E}^{′} ( {𝔽}_{{q}^{k / d}} ) , P ∈ E ( {𝔽}_{q} ) , and f ∈ {𝔽}_{{q}^{k}}^{*} .$
Optimal Ate pairing over BLS curve

Input: Q ∈ [symbol] ₂, P ∈ [symbol] ₁, curve parameter u

| Steps: | |
|---|---|
| 1. | f := 1 |
| 2. | T := Q |
| 3. | For i := └log(u)┘ - 1 down to 0 do: |
| 4. | f := f² |
| 5. | f := f · [symbol] _{Ψ(T),Ψ(T)}(P) |
| 6. | T := [2]T |
| 7. | If uᵢ = 1 then: |
| 8. | f := f · f · [symbol] _{Ψ(T),Ψ(Q)}(P) |
| 9. | T := T + Q |
| 10. | f := f^{(q}^{^{k}}^{-1)/r} |
| 11. | Return f |

Ψ is the twist Ψ: E′ → E. EC arithmetic is done in the twist E′ ( [symbol] _{q}^{k/d}). .
Computing line evaluations and f is done in [symbol] _{q}^{k}.

Thus, Miller algorithm accumulates ƒ_{i,Q}(P) iteratively using the above formulas in a ‘double-and-add’ style, and after that exponentiates

$$f := {f}_{ℓ , Q} ( P ) ,$$

$$to$$

$$\frac{{q}^{k} - 1}{r} ,$$

which is the result of the pairing, as shown in the table above.

Note 7. An important optimization that is incorporated is the so-called ‘denominator elimination’. It is not necessary to compute the evaluation of the vertical lines v[_{i+1]Q}, v_{[2i]Q}, as those terms will be mapped to 1 in the final exponentiation step. This optimization is only available to the Tate pairing and its variants in the type 3 setting, but not for the Weil pairing, because it uses the twisted curve and the final exponentiation step.

### 2. BLS12—Family Implementation Details

BLS12 has embedding degree k=12, and the curve has equation:

E:y²=x³+b,
with b=4. Recall from Table 1 that parameters q, r are derived accordingly to the BLS12-381 polynomials and curve parameter:

u=−2⁶³−2⁶²−2⁶⁰-2⁵⁷−2⁴⁸−2¹⁶.

Since a=0 it admits a sextic twist E′ (see Section 1.4) with equation:

E′: y²=x³+b′.

Here b′=b/Ξ where ξ is a non-square, non-cube element of [symbol] _{q}_{²}. Assuming p=3 mod 8, ξ:=1+\sqrt{−1}.

### 2.1 Fields Representation

The underlying field of the target group ( [symbol] _{q}_{¹²}) is represented with three different towers of extension fields.

### Representation 1 (Quadratic Extension)

[symbol] _{q}_{²}= [symbol] _{q}[u]/(u²+1)

[symbol]

_{q}_{⁶}= [symbol] _{q}_{²}[v]/(v³−ξ)

[symbol]

_{q}_{¹²}= [symbol] _{q}_{⁶}[w]/(w²−v)

In this representation, elements in [symbol] _{q}_{¹²} are given as a pair of elements in [symbol] _{q}_{⁶} (which are triplets of F_{q}_{²} elements).

### Representation 2 (Sextic Extension)

[symbol] _{q}_{²}= [symbol] _{q}[u]/(u²+1)

[symbol]

_{q}_{¹²}= [symbol] _{q}_{²}[t]/(t⁶−ξ)

Here elements in [symbol] _{q}_{¹²} are given as a vector of six elements in [symbol] _{q}_{²}.

### Representation 3 (Cubic Extension)

[symbol] _{q}_{²}= [symbol] _{q}[u]/(u²+1)

[symbol]

_{q}_{⁴}= [symbol] _{q}_{²}[s]/(s²−ξ)

[symbol]

_{q}_{¹²}= [symbol] _{q}_{⁴}[r]/(r³−s)

In this last representation elements in [symbol] _{q}_{¹²} are given as a triplet of elements in [symbol] _{q}_{⁴} (which are pairs of [symbol] _{q}_{²} elements).

Herein, [symbol] _{q} may be referred to as a first filed, [symbol] _{q}_{²} a second field, [symbol] _{q}_{⁴} a third field, [symbol] _{q}_{⁶} a fourth field, and [symbol] _{q}_{¹²} fifth field. The fifth field [symbol] _{q}_{¹²} is the target field.

### 2.1.1 Why Three Representations

In [symbol] _{q}_{¹²}, only the multiplication and inversion of elements is needed (the latter only for the easy part of the final exponentiation in the pairing computation). There exist well-known efficient algorithms for inversion over quadratic and cubic extensions. This means the first representation can be used, wherein [symbol] _{q}_{¹²} is a quadratic extension over [symbol] _{q}_{⁶} (and [symbol] _{q}_{⁶} is a cubic extension over [symbol] _{q}_{²}, and [symbol] _{q}_{²} is a quadratic extension over [symbol] _{q}). That is, arithmetic in [symbol] _{q}_{²} and in [symbol] _{q}_{⁶} is needed. Namely, addition subtraction, multiplication, negation, and inversion. Further, in this representation inversion of unitary [symbol] _{q}_{¹²} elements a+bw (that arise during the computation of the second part of the final exponentiation) can be computed by simple conjugation (a+bw)⁻¹:=(a−bw).

The second representation ( [symbol] _{q}_{¹²} as a sextic extension over [symbol] _{q}_{²}), is useful to exponentiate to powers of q using the Frobenius operator (for the final exponentiation). Frobenius is significantly more efficient than the standard square-and-multiply algorithm for q powers, requiring only 5 multiplications (with precomputations).

The third representation [symbol] _{q}_{¹²} as a cubic extension over [symbol] _{q}_{⁴}), will be used to perform multiplication in [symbol] _{q}_{¹²} in the Miller loop. The reason is that the result of the line functions can be represented very sparsely in the third representation. This fact can be used to split the Miller loop into two subroutines that exploit the sparsity in the prescribed multiplications within the loop. The varieties of sparse multiplications in [symbol] _{q}_{¹²} can be distinguished using this.

Based on the above remarks, the arithmetic formulas are specified in the following sections. They will serve as the codebase for the scripts detailed in Section 3.

### 2.1.2 Switching Between Representations

Switching between the first representation (quadratic extension) and the second one (sextic extension) will be used implicitly in exponentiations via Frobenius (see Section2.8). The output of the Miller loop (the ƒ element) is also switched from the first representation to the third one (cubic extension) before entering the final exponentiation.

[symbol] _{q}_{²} elements are pairs of [symbol] _{q} elements. Ultimately, [symbol] _{q}_{¹²} elements are always vectors of six [symbol] _{q}_{²} coefficients, but depending on the representation the rules governing the arithmetic are different. Switching representations just moves around the coefficients of a given element in [symbol] _{q}_{¹²}. The table below provides the precise permutation of the coefficients to switch among representations.

TABLE 3
Switching between representations of [symbol] _{q}¹² by moving
around the [symbol] _{q}² -coefficients a, b, c, d, e, f.
Switching between the three representations
Quadratic: X := ((a, b, c), (d, e, f)) ∈ [symbol] _{q}⁶ [w]/(w² - v)

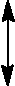

Sextic: X := (a, d, b, e, c, f ) ∈ [symbol] _{q}² [t]/(t⁶ - ξ )

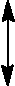

Cubic: X := ((a, e), (d, c), (b, f)) ∈ [symbol] _{q}⁴[r]/ (r³ - s )

Example. The switch between quadratic and sextic extension representations can be derived as set out below. Let X=x₁+x₂w be an element of the quadratic extension [symbol] _{q}_{¹²}= [symbol] _{q}_{⁶}[w]/(w²−v). The coefficients are elements in [symbol] _{q}_{⁶}:= [symbol] _{q}_{⁶}[w]/(w²−v), and can be written as:

x₁:=a+bv+cv²

x₂d+ev+dv²

where a, b, c, d, e, ƒ∈ [symbol] _{q}_{²}. Using that t=w and v=t², X can be expressed in the sextic extension [symbol] _{q}_{¹²}: [symbol] _{q}_{²}[t]/(t⁶−ι) by just switching around the [symbol] _{q}_{²}-coefficients:

$$\begin{matrix}X := {x}_{0} + {x}_{1} w = {x}_{0} + {x}_{1} t \\ = ( a + bv + {cv}^{2} ) + ( d + ev + {fv}^{2} ) t \\ = a + dt + {bt}^{2} + {et}^{3} + {ct}^{4} + {ft}^{5}\end{matrix}$$

2.2 Arithmetic in [symbol] _{q}_{²}—The Twisted Curve

Elements in [symbol] _{q}_{²} are polynomials X of degree one modulo u²+1. X can be identified with its two [symbol] _{q}-coefficients X̅:=(x₀, x₁).

[symbol]

_{q}_{²}:={X:=x₀+x₁u|x₀,x₁∈ [symbol] _{q},u²−1}.

Addition, subtraction, and scalar multiplication in [symbol] _{q}_{²} are defined in the natural way. Thus, addition and subtraction is component-wise, and scalar multiplication multiplies each component by the scalar λ∈ [symbol] _{q}_{²}. All operations are done modulo q.

TABLE 4

| | |
|---|---|
| Add in [symbol] _{_{q}}_{²} | Negate in [symbol] _{_{q}}_{²} |
| Input: X̅ := (x₀, x₁), Y̅ := (y₀, y₁) | Input: X̅ := (x₀, x₁) |
| Output: X̅ + Y̅ := (x₀ + y_{0,} x₁ + y₁) | Output: −X̅: = (−x₀, −x₁) |
| Subtract in [symbol] _{_{q}}_{²} | Multiply by scalar in [symbol] _{_{q}}_{²} |
| Input: X̅ := (x₀, x₁), Y̅ := (y₀, y₁) | Input: X̅ := (x₀, x₁), λ |
| Output: X̅ − Y̅ := (x₀ − y₀, x₁ − y₁) | Output: λX̅: = (λx₀, λx₁) |

Addition, subtraction, and negation in [symbol] _{_{q}}_{²} := [symbol] _{q} [u]/(u² + 1). ).
Here xᵢ, yᵢ, λ ϵ [symbol] _{q} and arithmetic is modulo q.

Multiplication of elements in [symbol] _{q}_{²}:= [symbol] _{q}[u]/(u²+1) is defined in the table 5 below. Squaring and multiplication by ξ:=u+1 as separate routines are also described.

TABLE 5
Multiplication, squaring, and inversion of elements in [symbol]
_{q}² := [symbol] _{q} [u]/(u² + 1 ).

| Multiply in [symbol] _{q}² | Square in [symbol] _{q}² |
|---|---|
| Input: X̅ := (x₀, x₁), | Input: X̅ := (x₀, x₁) |
| Y̅ := (y₀, y₁) | |
| Output: X̅ · Y̅ := | $Output : {\overline{X}}^{2} := ( {x}_{0}^{2} - {x}_{1}^{2} , 2 {x}_{0} {x}_{1} )$ |
| (x₀y₀ - x₁y₁, x₀y₁ + x₁y₀) | |
| Multiply by ξ := 1 + u in [symbol] _{q}² | Invert in [symbol] _{q}² |
| Input: X̅ := (x₀, x₁) | Input: X̅ := (x₀, x₁) |
| Output: X̅ · ξ := | Output: X̅⁻¹ := a₁(x₀, -x₁) |

(x₀ -1, x₀ + x₁)

$1. {a}_{0} := {x}_{0}^{2} .$
$2. {a}_{1} := {x}_{1}^{2} .$
3. a₀ := a₀ + a₁ // Always nonzero
${a}_{1} := - {a}_{0}^{- 1} // Inversion in {𝔽}_{q}$

Here xᵢ, yᵢ, aᵢ ∈ [symbol] _{q} and arithmetic is modulo q. Also, a₁(x₀, -x₁) is multiplication by scalar in [symbol] _{q}² (see table 4, bottom right).

2.3 Arithmetic in [symbol] _{q}_{⁴}

Elements in [symbol] _{q}_{⁴}= [symbol] _{q}_{²}[s]/(s²−ξ) are polynomials X of degree 1 modulo s²−ξ.

[symbol]

_{q}_{⁴}:={X:x₀+x₁s|xᵢ∈ [symbol] _{q}_{²},s²=ξ}

X is identified with its two [symbol] _{q}_{²}-coefficients X̅:=(x̅₀,x̅₁). Thus, x̅ᵢ∈ [symbol] _{q}_{²}. The formulas for arithmetic in [symbol] _{q}_{⁴} in terms of [symbol] _{q}_{²} arithmetic are given in the table below. Subtraction, negation, and inverse in [symbol] _{q}_{⁴} are omitted as these are not needed for computing a pairing.

TABLE 6
Arithmetic in [symbol] _{q}_{⁴} := [symbol] _{q}_{²}[s]/(s² − ξ).

| | |
|---|---|
| Multiply in [symbol] _{q}_{⁴} | Square in [symbol] _{q}_{⁴} |
| Input: X̅ := (x̅₀, x̅₁), Y̅ := (y̅₀, y̅₁) | Input: X̅ := (x̅₀, x̅₁) |
| Output: X̅ · Y̅ := (z̅₀, z̅₁) | $Output : {\overline{X}}^{2} := ( {\overline{x}}_{0}^{2} - {\overline{x}}_{1}^{2} , 2 {\overline{x}}_{0} \cdot {\overline{x}}_{1} )$ |
| z̅₀ := x̅₀ · y̅₀ + x̅₁ · y̅₁ · ξ | |
| z̅₁ := x̅₀ · y̅₁ + x̅₁ · y̅₀ | |
| Multiply by scalar in [symbol] _{q}_{⁴} | Multiply by s in [symbol] _{q}_{⁴} |
| Input: X̅ := (x̅₀, x̅₁), λ̅ | Input: X̅ := (x̅₀, x̅₁) |
| Output: λ̅X̅: = (λ̅ · x̅₀, λ̅ · x̅₁) | Output: X̅ · s := (x̅₁ · ξ, x̅₀) |
| Add in [symbol] _{q}_{⁴} | |
| Input: X̅ := (x̅₀, x̅₁), Y̅ := (y̅₀, y̅₁) | |
| Output: X̅ + Y̅: = (x̅₀ + y̅₀, x̅₁ + y̅₁) | |

Here x̅ᵢ, y̅ᵢ, λ̅ are in [symbol] _{q}_{²}. See Section 2.2 for arithmetic in [symbol] _{q}_{²}.
Also, x̅ · ξ is multiplication by ξ (see table 5, bottom left).

2.4 Arithmetic in [symbol] _{q}_{⁶}

Elements in [symbol] _{q}_{⁶}= [symbol] _{q}_{²}[v]/(v³−ξ) are polynomials X of degree 2 modulo v³−ξ.

[symbol]

_{q}_{⁶}:{X:x₀+x₁v+x₂v²|xᵢ∈ [symbol] _{q}_{²},v⁶=ξ}

X can be identified with its three [symbol] _{q}_{²}-coefficients X̅:=(x̅₀, x̅₁, x̅₂). The formulas for arithmetic in [symbol] _{q}_{⁶} in terms of [symbol] _{q}_{²} arithmetic are given in table 7 and table 8.

TABLE 7

| | |
|---|---|
| Add in [symbol] _{_{q}}_{⁶} | Negate in [symbol] _{_{q}}_{⁶} |
| Input: X̅ := (x̅₀, x̅₁, x̅₂), Y̅ := (y̅₀, y̅₁, y̅₂) | Input: X̅ := (x̅₀, x̅₁, x̅₂) |
| Output: X̅ + Y̅ := (x̅₀ + y̅₀, x̅₁ + y̅₁, x̅₂ + | Output: −X̅: = (−x̅₀, −x̅₁, −x̅₂) |
| Subtract in [symbol] _{_{q}}_{⁶} | Multiply by scalar in [symbol] _{_{q}}_{⁶} |
| Input: X̅ := (x̅₀, x̅₁, x̅₂), Y̅ := (y̅₀, y̅₁, y̅₂) | Input: X̅ := (x̅₀, x̅₁), λ̅ |
| Output: X̅ − Y̅ := (x̅₀ − y̅₀, x̅₁ − y̅₁, x̅₂ − | Output: λ̅ · X̅: = (λ̅ · x̅₀, λ̅ · x̅₁) |

Addition, subtraction, and negation in [symbol] _{_{q}}_{⁶} := [symbol] _{_{q}}_{²} [v]/(v³ − ξ).
Here x̅ᵢ, y̅ᵢ, λ̅ ϵ [symbol] _{_{q}}_{²}.
See Section 2.2 for the arithmetic in [symbol] _{_{q}}_{²}.

TABLE 8
Multiplication, squaring, and inversion of elements
in [symbol] _{q}_{⁶} := [symbol] _{q}_{²}[v]/{v³ − ξ).

| Multiply in [symbol] _{q}_{⁶} | Square in [symbol] _{q}_{⁶} | |
|---|---|---|
| Input: X̅ := (x̅₀, x̅₁, x̅₂), | Input: X̅ := (x̅₀, x̅₁, x̅₂) | |
| Y̅ := (y̅₀, y̅₁, y̅₂) | | |
| Output: X̅ · Y̅ := (z̅₀, z̅₁, z̅₂) | Output: X̅² := (z̅₀, z̅₁, z̅₂) | |
| z̅₀ := x̅₀ · y̅₀ + (x̅₁ · y̅₂ + x̅₂ · y̅₁) · ξ | ${\overline{z}}_{0} := {\overline{x}}_{0}^{2} + 2 {\overline{x}}_{1} \cdot {\overline{x}}_{2} \cdot ξ$ | |
| z̅₁ := x̅₀ · y̅₁ + x̅₁ · y̅₀ + x̅₂ · y̅₂ · ξ | ${\overline{z}}_{1} := 2 {\overline{x}}_{0} \cdot {\overline{x}}_{1} + {\overline{x}}_{2}^{2} \cdot ξ$ | |
| z̅₂ := x̅₀ · y̅₂ + x̅₁ · y̅₁ + x̅₂ · y̅₀ | ${\overline{z}}_{2} := 2 {\overline{x}}_{0} \cdot {\overline{x}}_{2} + {\overline{x}}_{1}^{2}$ | |
| Multiply by v in [symbol] _{q}_{⁶} | Invert in [symbol] _{q}_{⁶} | |
| Input: X̅ := (x̅₀, x̅₁, x̅₂) | Input: X̅ := (x̅₀, x̅₁, x̅₂) | |
| Output: X̅ · v := (x̅₂ · ξ, x̅₀, x̅₁) | Output: X⁻¹ := (z̅₀, z̅₁, z̅₂) | |
| | 1. | $\overline{a} := {\overline{x}}_{0}^{2} - {\overline{x}}_{1} \cdot {\overline{x}}_{2} \cdot ξ$ |
| | 2. | $\overline{b} := {\overline{x}}_{2}^{2} \cdot ξ - {\overline{x}}_{0} \cdot {\overline{x}}_{1}$ |
| | 3. | $\overline{c} := {\overline{x}}_{1}^{2} - {\overline{x}}_{0} \cdot {\overline{x}}_{2}$ |
| | 4. | d̅ := x̅₁ · ξ · d̅ + x̅₀ · d̅ + |
| | | x̅₂ · ξ · b̅ |
| | 5. | ē := d̅⁻¹ // Inversion in [symbol] _{q}_{²} |

```
  z̅₀ := d̅ · ē
  z̅₁ := b̅ · ē
  z̅₀ := d̅ · ē
```

Here x̅ᵢ, y̅ᵢ, ā, b̅, c̅, f̅, ξ ∈ [symbol] _{q}_{²}. See Section 2.2 for the arithmetic in [symbol] _{q}_{²}. See Section 2.2 for the arithmetic in [symbol] _{q}_{²}. Also, x̅ · ξ is multiplication by ξ (see Table 5, bottom left).

2.5 Arithmetic in [symbol] _{q}_{¹²}—The Target Field

In the target filed, vectors have 12 components. Herein, a sparse vector is considered to have at least 6 elements set to zero, while a some-what spare vector has at least 2 elements set to zero.

### 2.5.1 Multiplication as a Quadratic Extension

In the final exponentiation of the pairing [symbol] _{q}_{¹²} is given as a quadratic extension over [symbol] _{q}_{⁶}.

Namely, [symbol] _{q}_{¹²}= [symbol] _{q}_{⁶}[w]/(w²−v). In this representation, elements are polynomials X of degree 1 modulo w²−v with coefficients in [symbol] _{q}_{⁶}:= [symbol] _{q}_{²}[v]/(v³−ξ). Thus:

[symbol]

_{q}_{¹²}:={X:=x₀+x₁w|xᵢ∈ [symbol] _{q}_{⁶},w²v}.

X is identified with its two [symbol] _{q}_{⁶}-coefficients X̅:=(x₀, x₁). Recall that xᵢ∈ [symbol] _{q}_{⁶} is a vector of three [symbol] _{q}_{²} elements, x̅₀:=(ā, b̅, c̅) and x̅₁:=(d̅, ē, ƒ̅). Thus, X̅ is a vector of six [symbol] _{q}_{²} coefficient, seen as a pair of triplets:

X̅:=(x̅₀,x̅₁):=((ā,b̅,c̅),(d̅,ē,ƒ̅)).

The formulas for multiplication, squaring and inversion in [symbol] _{q}_{¹²} in terms of [symbol] _{q}_{⁶} arithmetic are given in Table 9. Inversion of unitary elements is done via conjugation, which is very efficient. This is an advantage of representing [symbol] _{q}_{¹²} as a quadratic extension in the final exponentiation.

TABLE 9
Multiplication, squaring, and inversion of
elements in [symbol] _{q}_{¹²} := [symbol] _{q}_{⁶}[w]/(w² − v).

| | |
|---|---|
| Multiply in [symbol] _{q}_{¹²} | Square in [symbol] _{q}_{¹²} |
| Input: X̅ := (x̅₀, x̅₁), Y̅ := (y̅₀, y̅₁) | Input: X̅ := (x̅₀, x̅₁) |
| Output: X̅ · Y̅ := | $Output : {\overline{X}}^{2} := ( {\overline{x}}_{0}^{2} - {\overline{x}}_{1}^{2} , 2 {\overline{x}}_{0} \cdot {\overline{x}}_{1} )$ |
| (x̅₀ · y̅₀ − x̅₁ · y̅₁, x̅₀ · y̅₁ + x̅₁ · y̅₀) | |
| Invert in [symbol] _{q}_{¹²} | Conjugate // Inversion of unitary |
| | elements |
| Input: X̅ := (x̅₀, x̅₁) | Input: X̅ := (x̅₀, x̅₁) |
| Output: X̅⁻¹ := ā₁ (x̅₀, −x̅₁) | Output: x := (x̅₀, −x̅₁) |

| | |
|---|---|
| 1. | ${\overline{a}}_{0} := {\overline{x}}_{0}^{2}$ |
| 2. | ${\overline{a}}_{1} := {\overline{x}}_{1}^{2}$ |
| 3. | ā₀ := ā₀ − ā₁ · v // Always nonzero |
| 4. | ${\overline{a}}_{1} := {\overline{a}}_{0}^{- 1} // Inversion in {𝔽}_{{q}^{6}} .$ |

Here x̅ᵢ, y̅ᵢ, āᵢ, v ∈ [symbol] _{q}_{⁶}. See Section 2.4 for the arithmetic in [symbol] _{q}_{⁶}. Also, ā₁ (x̅₀, −x̅₁) is multiplication by scalar in [symbol] _{q}_{⁶} (see Table 7 bottom right) and ā₁ · v is multiplication by v (see Table 8, bottom left).

### 2.5.2 Exponentiation as a Quadratic Extension

The final exponentiation may be said to be comprised of an easy part and a hard part. These terms are used in the art.

In the hard part of the final exponentiation, exponentiation to u and u/2 is required (u is the curve parameter). These exponentiations are done through the generic algorithm ‘signed square-and-multiply’. Thus, the exponent e (either u or u/2) is given in binary signed format, i.e. with bits in eᵢ∈{−1,0,1}. The algorithm can only be used to exponentiate unitary elements (i.e. in the hard part of the final exponentiation). See Table 10.

TABLE 10
Exponentiation of unitary elements in [symbol] _{q}_{¹²}.

Exponentiate unitary element in
${𝔽}_{{q}^{12}} // Fixed exponent e = {\sum }_{i = 0}^{ℓ - 1} {e}_{i} {2}^{i} with {e}_{i} ∈ \{ - 1 , 0 , 1 \}$
Input: f ∈ [symbol] _{q}_{⁶} := [symbol] _{q}_{⁶} [w]/ (w² − v) s.t. f^{q}^{⁶}⁺¹ = 1 (unitary element)
Output: f^{e} ∈ [symbol] _{q}_{¹²}

| | |
|---|---|
| 1. | g := f |
| 2. | For i := [symbol] − 2 down to 0 do: |
| 3. | g := g² |
| 4. | If eᵢ = 1 then |
| | g := g · f |
| 5. | Else if eᵢ = − 1 then: |
| | g := g · \hat{f} // Compute inverse of unitary f via conjugation: f⁻¹ = \hat{f} |
| 6. | End if |
| 7. | End for |
| 8. | Output g |

Multiplication, squaring, and conjugation are defined in Table 9.

### 2.5.3 Multiplication as a Cubic Extension

During the Miller loop, different formulas for multiplying in [symbol] _{q}_{¹²} are used that exploit the sparsity of the results of the line function evaluations. [symbol] or this, [symbol] _{q}_{¹²} is represented as a cubic extension over [symbol] _{q}_{⁴}:= [symbol] _{q}_{²}[s]/(s²−ξ). Namely [symbol] _{q}_{¹²}:= [symbol] _{q}_{⁴}[r]/(r³−s). Thus, elements in [symbol] _{q}_{¹²} are seeing as polynomials X of degree 2 modulo r³−s.

[symbol]

_{g}_{¹²}:={X:=x₀+x₁r+x₂r²|xᵢ∈ [symbol] _{q}_{⁴},r³=s}.

In this representation, X is identified with its three [symbol] _{q}_{⁴}-coefficients X̅:=(x̅₀, x̅₁, x̅₂). Since each x̅ᵢ∈ [symbol] _{q}_{⁴} is a vector of two [symbol] _{q}_{²} elements, X̅ is a vector of six [symbol] _{q}_{²} coefficients, seen as a triplet of pairs:

X̅:=(x̅₀,x̅₁,x̅₂)=(ā,b̅),(c̅,d̅),(ē,ƒ̅)).

The results L of the line calculations are sparse elements, with half of their coefficients set to zero (see Section 2.7 below). Namely, [symbol] _{q}_{¹²} elements are given in the form:

S̅=((ā,b̅),(c̅,0̅),(0̅,0̅)),

where the third [symbol] _{q}_{⁴} element is zero (ē,ƒ̅)=(0̅,0̅), and so is the second component of the second [symbol] _{q}_{⁴} element d̅=0̅. These are held in vectors of just three [symbol] _{q}_{²}-coefficients: X̅ₛ:=(ā, b̅, c̅)//Sparse representation of L̅

In the course of the Miller loop, sparse elements are multiplied by sparse elements. The result is a somewhat sparse element (i.e. the second component of the third [symbol] _{q}_{⁴} coefficient set to zero, ƒ̅=0̅) of the form:

X̅_{sw}:=(ā,b̅,c̅,d̅,ē).

Also, during the Miller loop, either a sparse S̅ or a somewhat sparse S̅′ is multiplied by a standard (dense) element X̅. In this way, the sparsity of S̅ and S̅′ is exploited in these types of multiplications. The different types of multiplications are given in Table 11. Note that, in order to exploit the sparsity, the formulas are low level, i.e. they are given in terms of [symbol] _{q}_{²} arithmetic.

TABLE 11

| | |
|---|---|
| Multiply sparse by sparse in [symbol] _{_{q}}_{¹²}. | Multiply somewhat-sparse by somewhat-sparse in [symbol] _{_{q}}_{¹²} |
| Input: | Input: |
| X̅_{s, 1} := (ā₁, b̅₁, c̅₁) // sparse a₁ + b₁s + c₁r | X̅_{sw, 1} := (ā₁, b̅₁, c̅₁, d̅₁, ē₁) // somewhat- |
| X̅_{s, 2} := (ā₂, b̅₂, c̅₂) // sparse | sparse ā₁ + b̅₁s + (c̅₁ + d̅₁s)r + ē₁r² |
| Output: X̅_{sw} := X̅_{s, 1} . X̅_{s, 2} := (ā₃, b̅₃, c̅₃, d̅, ē)) // | X̅_{sw, 2} := (ā₂, b̅₂, c̅₂, d̅₂, ē₂) // somewhat-sparse |
| somewhat-sparse ā₃ + b̅₃s + c̅₃r + d̅sr + ēr² | Output: X̅_{sw, 1} · X̅_{sw, 2}: = (ā₃, b̅₃, c̅₃, d̅₃, ē₃, f̅) |
| ā₃ := ā₁ā₂ + b̅₁b̅₂ξ | // ā₃ + b̅₃s + c̅₃r + d̅₃sr + (ē₃ + f̅s)r² |
| b̅₃ := b̅₁ā₂ + ā₁b̅₂ | ā₃ := ā₁ā₂ + b̅₁b̅₂ξ + ē₁d̅₂ξ + d̅₁ē₂ξ |
| c̅₃ := c̅₁ā₂ + ā₁c̅₂ | b̅₃ := b̅₁ā₂ + ā₁b̅₂ + ē₁c̅₂ + c̅₁ē₂ |
| d̅ := c̅₁b̅₂ + b̅₁c̅₂ | c̅₃ := c̅₁ā₂ + ā₁a₂ + d̅₁b̅₂ξ + b̅₁d̅₂ξ |
| ē := c̅₁c̅₂ | d̅₃ := d̅₁ā₂ + c̅₁b̅₂ + b̅₁c̅₂ + ā₁d̅₂ + ē₁ē₂ |
| | ē₃ := ē₁ā₂ + c̅₁c̅₂ + d̅₁d̅₂ξ + ā₁ē₂ |
| | f̅ := ē₁b̅₂ + d̅₁c̅₂ + c̅₁d̅₂ + b̅₁ē₂ |

TABLE 11
Multiply sparse by somewhat-sparse in [symbol] _{_{q}}_{¹²}
Input:
X̅ₛ := (ā₁, b̅₁, c̅₁) // sparse
X̅_{sw} := (ā₂, b̅₂, c̅₂, d̅₂, ē₂) // somewhat-sparse
Output: X̅ₛ · X̅_{sw} := (ā₃, b̅₃, c̅₃, d̅₃, ē₃, f̅) //dense
ā₃ := ā₁ā₂ + b̅₁b̅₂ξ
b̅₃ := b̅₁ā₂ + ā₁b̅₂ + c̅₁ē₂
c̅₃ := c̅₁ā₂ + ā₁c̅₂ + b̅₁d̅₂ξ
d̅₃ := c̅₁b̅₂ + b̅₁c̅₂ + ā₁d̅₂
ē₃ := c̅₁c̅₂ + ā₁ē₂
f̅ := c̅₁d̅₂ + b̅₁ē₂
Multiply sparse by dense in [symbol] _{_{q}}_{¹²}.
Input:
X̅ₛ = (ā₁, b̅₁, c̅₁) // sparse
X̅_{d} := (ā₂, b̅₂, c̅₂, d̅₂, ē₂, f̅₂) // dense
Output: X̅ₛ · X̅_{d}: = (ā₃, b̅₃, c̅₃, d̅₃, ē₃, f̅₃) //dense
ā₃ := ā₁ā₂ + b̅₁b̅₂ξ + c̅₁f̅₂ξ
b̅₃ := b̅₁ā₂ + ā₁b̅₂ + c̅₁ē₂
c̅₃ := c̅₁ā₂ + ā₁c̅₂ + b̅₁d̅₂ξ
d̅₃ := c̅₁b̅₂ + b̅₁c̅₂ + ā₁d̅₂
ē₃ := c̅₁c̅₂ + ā₁ē₂ + b̅₁f̅₂ξ
f̅₃ := c̅₁d̅₂ + b̅₁ē₂ + ā₁f̅₂
Multiply somewhat-sparse by dense in [symbol] _{_{q}}_{¹²}
Input:
X̅_{sw} := (ā₁, b̅₁, c̅₁, d̅₁, ē₁) // somewhat-sparse
X̅_{d} := (ā₂,b̅₂,c̅₂, d̅₂, ē₂, f̅₂) // dense
Output: X̅_{sw} · X̅_{d}: = (ā₃, b̅₃, c̅₃, d̅₃, ē₃, f̅₃) //
ā₃ + b̅₃s + c̅₃r + d̅₃sr + (ē₃ + f̅₃s)r²
ā₃ := ā₁ā₂ + b̅₁b̅₂ξ + ē₁d̅₂ξ + d̅₁ē₂sξ +
c̅₁f̅₂ξ
b̅₃ := b̅₁ā₂ + ā₁b̅₂ + ē₁c̅₂ + c̅₁ē₂ + d̅₁f̅₂ξ
c̅₃ := c̅₁ā₂ + ā₁c̅₂ + d̅₁b̅₂ξ + b̅₁d̅₂ξ + ē₁f̅₂ξ
d̅₃ := d̅₁ā₂ + c̅₁b̅₂ + b̅₁c̅₂ + ā₁d̅₂ + ē₁ē₂
ē₃ := ē₁ā₂ + c̅₁c̅₂ + d̅₁d̅₂ξ + ā₁ē₂ + b̅₁f̅₂ξ
f̅₃ := ē₁b̅₂ + d̅₁c̅₂ + c̅₁d̅₂ + b̅₁ē₂ + ā₁f̅₂
Multiplication in [symbol] _{_{q}}_{¹²} := [symbol] _{_{q}}₄[r]/(r³ − s ) for elements containing some sparsity.
Here āᵢ, b̅ᵢ, c̅ᵢ, d̅ᵢ, ēᵢ, f̅ᵢ ϵ [symbol] _{_{q}}_{²}.
See section 2.2 for arithmetic over [symbol] _{_{q}}_{²}.

Multiplying and squaring in the cubic representation is not essential, but it may be used to avoid unnecessary switching between representations in the Miller loop, that is to avoid introducing opcodes overhead. See Table 12.

TABLE 12
Multiplication and squaring, in [symbol] _{q}_{¹²} := [symbol] _{q}_{⁴}[r]/(r³ − s).

| | |
|---|---|
| Multiplication in [symbol] _{q}_{¹²} in Miller loop. | Square in [symbol] _{q}_{¹²} in Miller loop. |
| Input: X̅ := (x̅₀, x̅₁, x̅₂), X̅ := (y̅₀, y̅₁, y̅₂) | Input: X̅ := (x̅₀, x̅₁, x̅₂) |
| Output: X̅ · Y̅ := (z̅₀, z̅₁, z̅₂) | Output: X̅² := (z̅₀, z̅₁, z̅₂) |
| z̅₀ := x̅₀y̅₀ + x̅₂y̅₁s + x̅₁y̅₂s | ${\overline{z}}_{0} := {\overline{x}}_{0}^{2} + 2 {\overline{x}}_{1} \cdot {\overline{x}}_{2} \cdot s$ |
| z̅₁ := x̅₁y̅₀ + x̅₀y̅₁ + x̅₂y̅₂s | ${\overline{z}}_{1} := 2 {\overline{x}}_{0} \cdot {\overline{x}}_{1} + {\overline{x}}_{2}^{2} \cdot s$ |
| z̅₂ := x̅₂y̅₀ + x̅₁y̅₁ + x̅₀y̅₂ | ${\overline{z}}_{2} := 2 {\overline{x}}_{0} \cdot {\overline{x}}_{2} + {\overline{x}}_{1}^{2}$ |

Here x̅ᵢ, y̅ᵢ, z̅ᵢ, s ∈ [symbol] _{q}_{⁴}. See Section 2.3 for the arithmetic in [symbol] _{q}_{⁴}. Also, x̅ · s is multiplication by s (see Table 6, centre right).

2.6 EC Arithmetic in the Twisted Curve E′( [symbol] _{q}_{²})

Let two points T:=(x̅₁, y̅₁, z̅₁), Q:=(x̅₂, y̅₂) in the twisted curve E′( [symbol] _{q}_{²}). Thus T, Q are in the second source group [symbol] ₂. Note that T is in projective coordinates, and Q in affine coordinates. Regardless of how they are expressed, points in the twisted curve E′( [symbol] _{q}_{²}) have coordinates in [symbol] _{q}_{²}. The points T+Q and [2]T can be computed according to the formulas shown in Table 13.

TABLE 13
Top: Point addition in the twisted curve. Bottom: Point doubling.

```
Point addition in E′ ( [symbol] _{q}_{²})
Input: T := (x̅₁, y̅₁, z̅₁), Q := (x̅₂, y̅₂)
Output: T + Q := (x̅₃, y̅₃, z̅₃)
    x̅₃ = λ̅ · (λ̅³ + z̅₁ · θ̅² − 2x̅₁ · λ̅²)
    y̅₃ = θ̅ · (3x̅₁ · λ̅² − λ̅³ − z̅₁ · θ̅²) − y̅₁ · λ̅³
    z̅₃ = z̅₁ · λ̅³
Where λ̅ := x̅₁ − x̅₂ · z̅₁ and θ̅ := y̅₁ − y̅₂ · z̅₁
Point doubling in E′ ( [symbol] _{q}_{²})
Input: T := (x̅₁, y̅₁, z̅₁)
Output: [2]T := (x̅₃, y̅₃, z̅₃)
    ${\overline{x}}_{3} := \frac{1}{2} {\overline{x}}_{1} \cdot {\overline{y}}_{1} ( {\overline{y}}_{1}^{2} - 9 {b}^{′} \cdot {\overline{z}}_{1}^{2} )$
    ${\overline{y}}_{3} := {( \frac{1}{2} ( {\overline{y}}_{1}^{2} + 9 {b}^{′} \cdot {\overline{z}}_{1}^{2} ) )}^{2} - 27 {b}^{′} \cdot {\overline{z}}_{1}^{4}$
    ${\overline{z}}_{3} := 2 {\overline{y}}_{1}^{3} \cdot {\overline{z}}_{1}$
$Where {b}^{′} := b {ξ}^{- 1} and {ξ}^{- 1} := ( 1 , - \frac{1}{2} ) in {𝔽}_{{q}^{2}} := {𝔽}_{q} [ ξ ] / ( {ξ}^{2} - 2 ξ + 2 ) .$
T is in projective coordinates and Q in affine coordinates. Here x̅ᵢ, y̅ᵢ, z̅ᵢ ∈ [symbol] _{q}_{²}, see Section 2.2 for arithmetic over [symbol] _{q}_{²}.
```

2.7 Evaluation Line Functions in the Target Field [symbol] _{q}_{¹²}

Let two points T:=(x̅₁, y̅₁, z̅₁), Q:=(x̅₂, y̅₂) in the twisted curve E′( [symbol] _{q}_{²}) in projective and affine coordinates, respectively. Also, let a point P (xₚ,yₚ) in E( [symbol] _{q}) in affine coordinates. The point P is in the first source group [symbol] ₁ and has coordinates in [symbol] _{q}. The points T, Q are in the second source group [symbol] ₂ and have coordinates in [symbol] _{q}_{²}.

2.7.1 Line for Point Addition g_{Ψ(T),Ψ(Q)}

The evaluation at P of the line g_{Ψ(T),Ψ(Q)} that passes through the untwisted points Ψ(T) and Ψ(Q) is computed. The result of the evaluation in [symbol] _{q}_{¹²}:= [symbol] _{q}_{⁴}[r]/(r³−s) can be expressed as follows:

$${ℊ}_{Ψ ( T ) , Ψ ( Q )} ( P ) := {x}_{0} + {x}_{1} r + {x}_{2} {r}^{2}$$

$$such that$$

$$\{ \begin{matrix}{\overline{x}}_{0} := ( \overline{a} , \overline{b} ) ∈ {𝔽}_{{q}^{4}} \\ {\overline{x}}_{1} := ( \overline{c} , \overline{0} ) ∈ {𝔽}_{{q}^{4}} \\ {\overline{x}}_{2} := ( \overline{0} , \overline{0} ) ∈ {𝔽}_{{q}^{4}}\end{matrix}$$

The result is a sparse polynomial only with three nonzero [symbol] _{q}_{²}-coordinates. Therefore, g_{Ψ(T),Ψ(Q)}(P) can be represented in sparse form as a vector of three [symbol] _{q}_{²}-coordinates: g_{Ψ(T),Ψ(Q)}(P) in sparse form:=(ā, b̅, c̅).

Table 14 provides explicit formulas which can be used to calculate the coefficients ā, b̅, c̅.

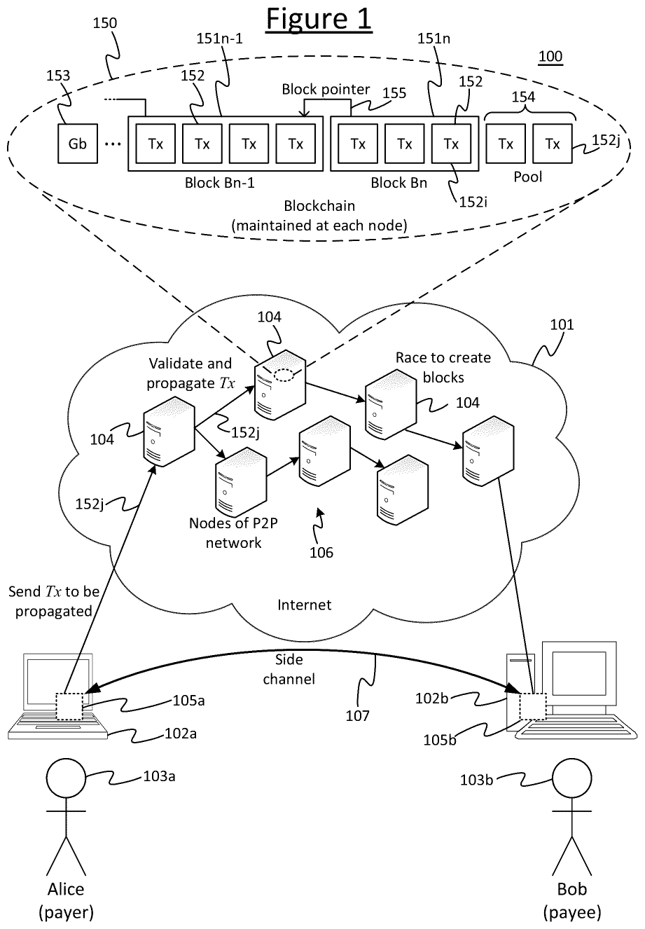

FIG. 1: Formulas for computing the line evaluation of a point addition in
${𝔽}_{q}^{12} := {𝔽}_{{q}^{4}} [ r ] / ( {r}^{3} - s ) .$

```
Evaluate point addition line
Input: T := (x̅₁, y̅₁, z̅₁), Q := (x̅₂, y̅₂) P := (xₚ, yₚ)
Output: g_{Ψ(T),Ψ(Q)}(P) := (ā, b̅, c̅) // sparse form
    ā := (a₀, a₁) := −y_{P}λ̅ = −y_{P}(x̅₁ − x̅₂ · z̅₁)
    b̅ := (b₀, b₁) := −x_{P}θ̅ = (y̅₁ − y₂ · z̅₁) · x̅₂ − (x̅₁ − x̅₂ · z̅₁) · y̅₂
    c̅ := (c₀, c₁) := θ · x̅₂ − λ̅ · y̅₂ = −xₚ(y̅₁ − y̅₂ · z̅₁)
Here x̅ᵢ, y̅ᵢ, z̅ᵢ, ∈ [symbol] _{q}_{²}, and x_{P}, y_{P} ∈ [symbol] _{q} are scalars. Also λ̅ θ̅ are the same as in point addition (Table14, top). See Section 2.2 for arithmetic over [symbol] _{q}_{²}.
```

2.7.2 Line for Point Doubling g_{Ψ(T),Ψ(T)}

Likewise, the formula to compute the evaluation of the tangent line g_{Ψ(T),Ψ(T)} at P in [symbol] _{q}_{¹²}:= [symbol] _{q}_{⁴}[r]/(r³−s) is given by:

$${ℊ}_{Ψ ( T ) , Ψ ( T )} ( P ) := {x}_{0} + {x}_{1} r + {x}_{2} {r}^{2}$$

$$such that$$

$$\{ \begin{matrix}{\overline{x}}_{0} := ( {\overline{a}}^{′} , {\overline{b}}^{′} ) ∈ {𝔽}_{{q}^{4}} \\ {\overline{x}}_{1} := ( {\overline{c}}^{′} , \overline{0} ) ∈ {𝔽}_{{q}^{4}} \\ {\overline{x}}_{2} := ( \overline{0} , \overline{0} ) ∈ {𝔽}_{{q}^{4}}\end{matrix}$$

Again, g_{Ψ(T),Ψ(T)}(P) can be represented succinctly as a vector of three [symbol] _{q}_{²}-coordinates (ā′, \dot{b}′, c̅′). See Table 15 for the formulas to calculate coefficients ā′, b̅′, c̅′.

TABLE 15
Formulas for line evaluation of point doubling in
${𝔽}_{q}^{12} := {𝔽}_{{q}^{4}} [ r ] / ( {r}^{3} - s ) .$

```
Evaluate point doubling line
Input: T := (x̅, y̅, z̅), P := (x_{P}, y_{P})
Output: g_{Ψ(T),Ψ(T)}(P) := (ā′, b̅′, c̅′): // sparse form
    ā′ := −2yₚy̅₁ · z̅₁
    ${\overline{b}}^{′} := 3 {b}^{′} \cdot {\overline{z}}_{1}^{2} - {\overline{y}}_{1}^{2}$
    ${\overline{c}}^{′} := 3 {x}_{P} {\overline{x}}_{1}^{2}$
$\begin{matrix}Where {b}^{′} := b {ξ}^{- 1} and {ξ}^{- 1} := {( α + 1 )}^{- 1} = ( \frac{1}{2} , - \frac{1}{2} ) in \\ {𝔽}_{{q}^{2}} := {𝔽}_{q} [ α ] / ( {α}^{2} + 1 ) .\end{matrix}$
```

Here x̅, y̅, z̅, ∈ [symbol] _{q}_{²}, and x_{P}, y_{P} ∈ [symbol] _{q} are scalars. See Section 2.2 for arithmetic over [symbol] _{q}_{²}.

### 2.8 Exponentiation via Frobenius Endomorphisms

During the final exponentiation, powers of the form X^{q},X^{q}^{²}, X^{q}^{³} for a given [symbol] _{q}_{¹²}-element X are computed. These computations can be done efficiently, in just 5 multiplications over [symbol] _{q}_{²}, as set out below.

[symbol] _{q}_{¹²} is represented as a quadratic extension (first representation), thus X:=x₀+x₁t. To compute (x₀+x₁t)^{q}, when expanding out the expression, powers less than q vanish because they have a coefficient that is multiple of q (the field characteristic).

Next, for an [symbol] _{q}_{²} element a:=a₁+a₂u, it can be seed that

$${a}^{{q}^{{2}^{i}}} = a$$

$$and$$

$${a}^{{q}^{{2}^{i} - 1}} = \hat{a} ,$$

where â:=a₁−a₂u is the conjugate of a. Last, t=w, and that in the first representation t⁶=ξ so t^{q}=ξ^{(q-1)/6}t, which means that for i=1,2,3,4,5, t^{iq}=γ_{1,i}tⁱ, where γ_{1,i}=ξ^{i(q-1)/6}.

Therefore:

$$\begin{matrix}{X}^{q} = {( {x}_{0} + {x}_{1} w )}^{q} = {( {x}_{0} + {x}_{1} t )}^{q} \\ = {( ( a + bv + {cv}^{2} ) + ( d + ev + {fv}^{2} ) t )}^{q} \\ = {( a + dt + {bt}^{2} + e {t}^{3} + c {t}^{4} + {ft}^{6} )}^{q} // S witch to sextic extension ( See Table 3. ) \\ = â + \hat{d} {γ}_{1 , 1} t + \hat{b} {γ}_{1 , 2} {t}^{2} + ê {γ}_{1 , 3} {t}^{3} + \hat{c} {γ}_{1 , 4} {t}^{4} + \hat{f} {γ}_{1 , 5} {t}^{5} \\ = ( â + \hat{b} {γ}_{1 , 2} v + \hat{c} {γ}_{1 , 4} {v}^{2} ) + ( \hat{d} {γ}_{1 , 1} + ê {γ}_{1 , 3} v + \hat{f} {γ}_{1 , 5} {v}^{2} ) w // Switch back to quadratic extension\end{matrix}$$

Computing X^{q}^{²} and X^{q}^{³} is done similarly. See Table 16 for the formulas. It is observed that the [symbol] _{q}_{²}-elements γ_{j,i} for j=1,2,3, i=1,2,3,4,5 are precomputed and hard-coded it in the algorithms.

TABLE 16
q-powers via Frobenius. Elements a, b, c, d, e, f , γ_{j,i} are in [symbol] _{q}².
See Section 2.2 for arithmetic in [symbol] _{q}².
Elements γ_{j,i} are precomputed. Also, \hat{x} denotes the conjugate of x.

| | |
|---|---|
| q-Frobenius // Define γ_{1,i} == ξ^{i(q-1)/6} | q²-Frobenius // Define γ_{2,i} := γ_{1,i} · \hat{γ}_{1,i} |
| Input: X := (x̅₁, x̅₂) ϵ [symbol] _{q}⁶ [w]/ | Input: X := (x̅₁, x̅₂) ϵ [symbol] _{q}⁶ [w]/ |
| (w² − v) | (w² − v) |
| -x̅₁ := (a, b, c) | x̅₁ := (a, b, c) |
| -x̅₂ := (d, e, f) | x̅₂ := (d, e, f) |
| Output: X^{q} := (x̅′₁, x̅′₂) ϵ [symbol] _{q}⁶ [w]/ | Output: X^{q2} := (x̅′₁,x̅′₂) ϵ [symbol] _{q}⁶ [w]/ |
| (w² − v) | (w² − v) |
| -x̅′₁ := (â, \hat{b} · γ_{1,2},ĉ · γ_{1,4}) | x̅′₁ := (a,b · γ_{2,2},c · γ_{2,4}) |
| -x̅′₂ := (\hat{d} · γ_{1,1},ê γ_{1,3}, \hat{f} · γ_{1,5}) | x̅′₂ := (d · γ_{2,1},e · γ_{2,3},f · γ_{2,5}) |
| g³-Frobenius // Define γ_{1,i} := γ_{1,i} · γ_{2,i} | |
| Input: X := (x̅₁, x̅₂) ϵ [symbol] _{q}⁶ [w]/ | |
| (w² − v) | |
| -x̅₁ := (a, b, c) | |
| -x̅₂ := (d, e, f) | |
| Output: X^{q} := (x′₁, x′₂) ϵ [symbol] _{q}⁶ [w]/ | |
| (w² − v) | |
| -x̅′₁ := (â,\hat{b} γ_{3,2},ĉ · γ_{3,4}) | |
| -x̅′₂ := (\hat{d} · γ_{3,1},ê · γ_{3,3},\hat{f} · γ_{3,5}) | |

### 2.9 Final Exponentiation

The final exponentiation computes ƒ:ƒ=ƒ^{(q}^{¹²}^{-1)/r} in [symbol] _{q}_{^{k}}. The exponent can be expressed as:

$$e : = \frac{{q}^{k} - 1}{r} = [ \frac{{q}^{k} - 1}{{Φ}_{k} ( q )} ] [ \frac{{Φ}_{k} ( q )}{r} ] ,$$

where Φₖ(p) is the k-th cyclotomic polynomial.

A pairing friendly field may be defined as an extension [symbol] _{q}_{^{k}} with q≡1 mod 12 and q=2ⁱ3^{j}. i≥1. j≥0.

In such a pairing-friendly field [symbol] _{q}_{^{k}}, the exponent can be expressed as follows:

$$e = ( {q}^{k / 2} - 1 ) ( {q}^{k / 6} + 1 ) \frac{{q}^{k / 3} - {q}^{k / 6} + 1}{r} .$$

In BLS12 (and in BN for that matter), the embedding degree is k=12, so the above formula for the exponent becomes:

$$e = ( {q}^{6} - 1 ) ( {q}^{2} + 1 ) \frac{{q}^{4} - {q}^{2} + 1}{r} .$$

The part (q⁶−1)(q²+1) of the exponent is referred to as the first, or easy, part. The part

$$d : = \frac{{q}^{4} - {q}^{2} + 1}{r}$$

is referred to as the second, or hard, part. They are computed differently, as set out below.

### 2.9.1 Final Exponentiation—First (Easy) Part

Representing ƒ as an element in [symbol] _{q}_{¹²}= [symbol] _{q}_{⁶} [w]/(w²−v), the power ƒ^{q}^{⁴} is just its conjugate ƒ̅. Thus, if ƒ=a+bw, then ƒ^{q}^{⁶}=\hat{ƒ}:=a−bw. This means that the first part of the exponent is computed as

ƒ^{(q}^{⁶}^{-1)(q}^{²}⁺¹⁾=(ƒ^{q}^{⁶}ƒ⁻¹)^{q}^{²}⁺¹=(\hat{ƒ}ƒ⁻¹)^{q}^{²}⁺¹=(\hat{ƒ}ƒ⁻¹)^{g}^{²}\hat{ƒ}ƒ⁻¹.

Raising to q² is done with the Frobenius operator. See Table 17 for the algorithm to compute the easy part. This part is common to BN curves.

TABLE 17
Easy part of the final exponentiation.

| Exponentiate easy part: | |
|---|---|
| Input: f := (x̅, y̅) ∈ [symbol] _{q1}_{²} := [symbol] _{q6} [w]/ (w² − v) | |
| Output: g := (x̅′, y̅′) = f^{(q}^{⁶}^{-1)(q}^{²}⁺¹⁾ | |
| 1. | f₁ := f⁻¹ |
| 2. | f₂ := \hat{f} = (x̅, −y̅) // Conjugate f |
| 3. | f₃ := f₁ · f₂ |
| 4. | ${f}_{4} := {f}_{3}^{{q}^{2}} // {q}^{2} - Frobenius . See Table 16 , top right .$ |
| 5. | g := f₃ · f₄ |

Multiplication and inversion is carried over [symbol] _{q1}_{²} as a quadratic extension (see Table 9).

### 2.9.1 Final Exponentiation—Second (Hard) Part

The second part is specific for each curve. Herein, it is explained how to do it for BLS12. The output of the first part is g:=ƒ^{(q}^{⁶}^{-)(q}^{²}⁺¹⁾.

The second part consists in computing the exponentiation g^{d} where

$$d \text{:} = \frac{{q}^{4} - {q}^{2} + 1}{r}$$

First, the exponent is expressed as the sum d=λ₀+λ₁q+λ₂q²+Aλ₃q³, where the coefficients λᵢ are integers. This means that the result of the final exponentiation is:

ƒ^{e}=g^{d}=g^{λ}^{₀}^{+λ}^{₁}^{q+λ}^{₂}^{q}^{²}^{+λ}^{₃}^{q}^{³}.

The above exponentiation is typically done with an addition chain for specific coefficients of λᵢ (which depend on the parameterization of the prime q, hence on the specifics of each curve) and applying the Frobenius operators for the powers q, q², and q³. An addition chain is used which is optimized for BLS12. See Table 18 for the algorithm. The concrete values of λᵢ for which the addition chain applies are:

$$\{ \begin{matrix}{λ}_{0} = {λ}_{1} u + 3 \\ {λ}_{1} = {λ}_{2} u - {λ}_{3} \\ {λ}_{2} = λ u \\ {λ}_{3} = {u}^{2} - 2 u + 1\end{matrix}$$

where u is the curve parameter.

TABLE 18
Hard part exponentiation.

Exponentiate hard part: // curve parameter u hard-coded
Input: g := (x̅, y̅) ∈ [symbol] _{q}_{¹²} := [symbol] _{q6} [w]/(w² − v) // The output of the easy
part. (Table 17)
$Output : p := {g}^{\frac{{q}^{4} - {q}^{2} + 1}{r}} // The pairing output .$

| | |
|---|---|
| 1. | t₀ := g² |
| 2. | ${t}_{1} := {t}_{0}^{u} // See Table 10$ |
| 3. | ${t}_{2} := {t}_{1}^{u / 2} // See Table 10$ |
| 4. | t₃ := ĝ (= g⁻¹) // Conjugate - see Table 9 bottom right. |
| 5. | t₁ := t₃ · t₁ |
| 6. | ${t}_{1} := {\hat{t}}_{1} ( = {t}_{1}^{- 1} )$ |
| 7. | t₁ = t₁ · t₂ |
| 8. | ${t}_{2} := {t}_{1}^{u}$ |
| 9. | ${t}_{3} := {t}_{2}^{u}$ |
| 10. | ${t}_{1} := {\hat{t}}_{1} ( = {t}_{1}^{- 1} )$ |
| 11. | t₃ = t₁ · t₃ |
| 12. | ${t}_{1} := {\hat{t}}_{1} ( = {t}_{1}^{- 1} )$ |
| 13. | ${t}_{1} := {t}_{1}^{{q}^{3}} // {q}^{3} - Frobenius . See Table 16 bottom .$ |
| 14. | ${t}_{2} := {t}_{1}^{{q}^{2}} // {q}^{2} - Frobenius . See Table 16 top right .$ |
| 15. | t₁ := t₁ · t₂ |
| 16. | ${t}_{2} := {t}_{3}^{u}$ |
| 17. | t₂ := t₂ · t₀ |
| 18. | t₂ := t₂ · g |
| 19. | t₁ := t₁ · t₂ |
| 20. | ${t}_{2} := {t}_{3}^{q} // q - Frobenius . See Table 16 top left .$ |
| 21. | p := t₁ · t₂ |

The algorithm uses five temporary variables tᵢ. Multiplication is given in Table 9 and exponentiation by u, u/2 in Table 10.

### 3 Scripts

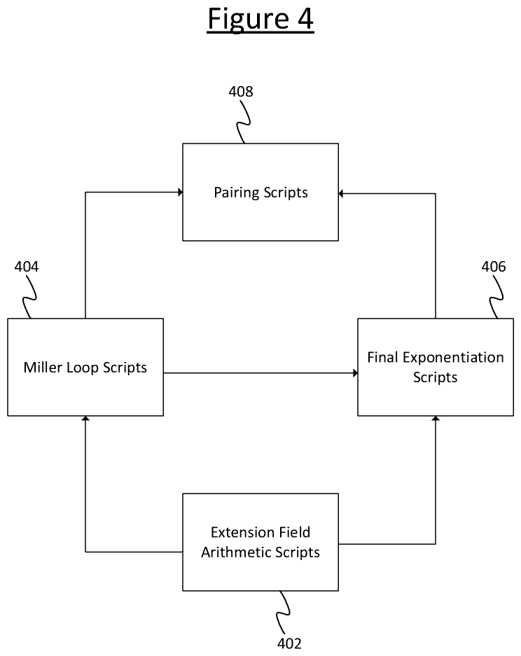

The scripts which may be used to implement a BLS12 pairing in Script are provided below. The scripts are broken into four major conceptual blocks: extension field arithmetic scripts 402, Miller loop scripts 404, final exponentiation scrips 406, and pairing scripts 408. The scripts to be used by external users are those in the pairing block 408. The other scripts 402, 404, 406 are internal. The conceptual division and dependence of scripts is shown in FIG. 4.

Some or all of script blocks may be used to compute the pairing. For example, the Miller loop script block 404 may be used together with a known final exponentiation script which computes the inverse. Other combinations of the script blocks may be implemented.

The scripts 402, 404, 406, and 408 may be referred to herein as computational blocks.

In the examples provide herein, the scripts are presented as blockchain scripts. However, it will be appreciated that the scripts may be any form of computer readable scripts. In particular, the scripts may be any form of bytecode or binary code. In such codes, any loops are expended. For example, instead of defining a branching script comprising if statements, each loop is defined consecutively to generate a script with no branching.

The scripts provided herein minimise the size of such branchless scripts.

### 3.1 Extension Field Arithmetic Scripts

The extension field arithmetic scripts perform arithmetic over the extension fields of the pairing. Namely, arithmetic over fields [symbol] _{q} [symbol] _{q}_{²}, [symbol] _{q}_{⁴}, [symbol] _{q}_{⁶}, [symbol] _{q}_{¹²}.

Available implementations to multiply and square over quadratic or cubic extensions of a given base field use Karatsuba multiplication, and the squaring complex method or Chung-Hasan squaring, respectively. These algorithms use few multiplications but more arithmetic operations over the base field in general. Thus, they are faster to execute, i.e. require fewer CPU cycles, but more costly to describe in scripts.

The scripts provided herein use algorithms that yield scripts with fewer opcodes. Therefore, these scripts are considered to be size-efficient.

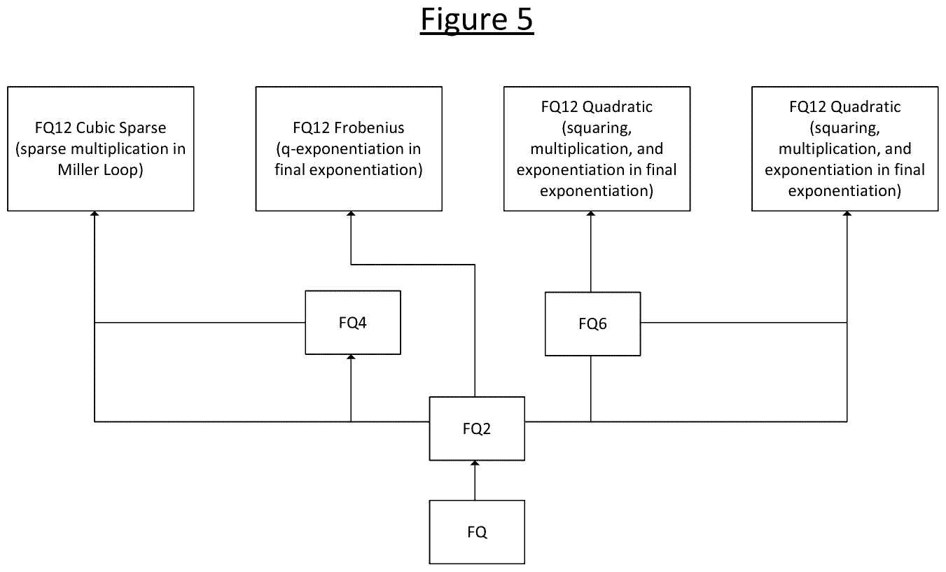

The extension field arithmetic block is split into eight groups—see FIG. 5. The scripts of the upper FQ12 groups are used in the Miller loop and final exponentiation parts of the pairing. The inner groups contain scripts necessary to implement operations in FQ12 ( [symbol] _{q}_{¹²}).

The scripts provided herein may be used to compute a pairing. The pairing may be computed by executing a set of sub-computations in a target field. Instead, the target field may be represented as an extension field and a sub-computation performed by a subfunctions over the extension field.

Sub-computations of the pairing computations may be performed by subfunctions executed over different extension fields. The elements output by the subfunctions can be transformed to be represented in a different extension field.

By using the subfunctions in extension fields, the size of the pairing computation in script is reduced, and therefore the computational efficiency of the computation increased.

### 3.1.1 FQ

Arithmetic over [symbol] _{q}. An FQ element is an integer x modulo q. Thus, 0≤x<q.

Implementation of addition, subtraction, negation, multiplication and squaring of modular integers can be done easily. Bitcoin Script supports modular arithmetic with native opcodes such as OP_ADD, OP_SUB, OP_MUL, OP_MOD.

### 3.1.2 FQ2

Arithmetic over [symbol] _{q}_{²}:= [symbol] _{q}[u]/(u2+1), with ξ:=u+1. An FQ2 element is a pair of integers x̅=(x₀, x₁) where 0≤xᵢ<q. Table 19 lists the scripts.

TABLE 19
Scripts of [symbol] _{q}² arithmetic

| Scripts | Description | Pseudocode reference |
|---|---|---|
| [FQ2 add] | Add two elements. | Table 4 |
| [FQ2 subtract] | Subtract two elements. | |
| [FQ2 negate] | Negate an element. | |
| [FQ2 multiply by scalar] | Multiply by an element in [symbol] _{q}. | |
| [FQ2 multiply] | Multiply two elements. | Table 5 |
| [FQ2 square] | Square an element. | |
| [FQ2 multiply by xi] | Multiply an element by | |
| | element ξ. | |

### 3.1.3 FQ4

Arithmetic over [symbol] _{q}_{⁴}:= [symbol] _{q}_{²}[s]/(s²−ξ). An FQ4 element is a pair of FQ2 elements x̅=(x̅₀, x̅₁) where x̅ᵢ∈ [symbol] _{q}_{²}. Table 20 lists the scripts.

TABLE 10
Scripts for [symbol] _{q}⁴ arithmetic

| Scripts | Description | Pseudocode reference |
|---|---|---|
| [FQ4 add] | Add two elements. | Table 6 |
| [FQ4 multiply] | Multiply two elements. | |
| [FQ4 square] | Square an element. | |
| [FQ4 multiply by scalar] | Multiply by an element in [symbol] _{q}². | |
| [FQ4 multiply by s] | Multiply an element by | |
| | element s. | |

### 3.1.4 FQ6

Arithmetic over [symbol] _{q}_{⁶}:= [symbol] _{q}_{²}[v]/(v³−ξ). An FQ6 element is a triplet of FQ2 elements x̅=(x̅₀, x̅₁, x̅₂) where x̅ᵢ∈ [symbol] _{q}_{²}. Table 21 lists the scripts.

TABLE 21
Scripts for [symbol] _{q}⁶ arithmetic

| Scripts | Description | Pseudocode reference |
|---|---|---|
| [FQ6 add] | Add two elements. | Table 7 |
| [FQ6 subtract] | Subtract two elements. | |
| [FQ6 negate] | Negate an element. | |
| [FQ6 multiply by scalar] | Multiply by an element in [symbol] _{q}². | |
| [FQ6 multiply] | Multiply two elements. | Table 8 |
| [FQ6 square] | Square an element. | |
| [FQ6 multiply by v] | Multiply an element by | |
| | element v. | |

### 3.1.5 FQ12Quadratic

Multiplication over [symbol] _{q}_{¹²}:= [symbol] _{q}_{⁶}[w]/(w²−v). Namely, a quadratic extension over [symbol] _{q}_{⁶}. An VQ12Quadratic element is a pair of FQ6 elements x̅=(x̅₀, x̅₁) where x̅ᵢ∈ [symbol] _{q}_{⁶}. Table 22 lists the scripts.

TABLE 22
Scripts for [symbol] _{q}¹² multiplications as a quadratic extension.

| | | Pseudocode |
|---|---|---|
| Scripts | Description | reference |
| [FQ12Quadratic multiply] | Multiply two elements. | Table 9 |
| [FQ12Quadratic square] | Square an element. | |

### 3.1.6 FQ12CubicSparse

Sparse multiplication and squaring over [symbol] _{q}_{¹²}:= [symbol] _{q}_{⁴}[r]/(r³−s). Namely, a cubic extension over [symbol] _{q}_{⁴}. The following types of elements are distinguished:
FQ12CubicSparse. A triplet of FQ2 elements x̅ₛ=(ā, b̅, c̅) where ā, b̅, c̅∈ [symbol] _{q}_{²}.
FQ12CubicSomewhatSparse. Five FQ2 elements x̅_{sw}=(ā, b̅, c̅, d̅, ē) where ā,b̅,c̅,d̅, ∈ [symbol] _{q}_{²}
FQ12CubicDense. Six FQ2 elements x̅_{d}=((ā, b̅), (c̅, d̅), (ē, ƒ̅)) where ā, b̅, c̅, d̅, ē, ƒ̅∈ [symbol] _{q}_{²} (Standard element in FQ12 as a cubic extension)

Table 23 lists the scripts.

TABLE 23
Scripts for [symbol] _{q}¹² sparse multiplications as a cubic extension.

| | | Pseudocode |
|---|---|---|
| Scripts | Description | reference |
| [FQ12Cubic multiply | Multiply two sparse | Table 11 |
| sparse by sparse] | elements. | |
| [FQ12Cubic multiply sparse by | Multiply a sparse | |
| somewhat-sparse] | element by a somewhat- | |
| | sparse element. | |
| [FQ12Cubic multiply | Multiply a sparse | |
| sparse by dense] | element by a dense | |
| | element. | |
| [FQ12Cubic multiply somewhat- | Multiply two somewhat | |
| sparse by somewhat-sparse] | sparse elements. | |
| [FQ12Cubic multiply somewhat- | Multiply a somewhat- | |
| sparse by dense] | sparse element by a | |
| | dense element. | |
| [FQ12Cubic multiply] | Multiply a (dense) | Table 12 |
| | element. | |
| [FQ12Cubic square] | Square a (dense) | |
| | element. | |

### 3.1.7 FQ12Invert

Inversion algorithms of elements in [symbol] _{q}_{¹²}. Inversion involves the following types of elements (defined in the previous sections):
FQ element
FQ2 element
FQ6 element
FQ12Quadratic element

Table 24 lists the scripts to invert elements.

TABLE 24
Scripts to invert elements

| | | Pseudocode |
|---|---|---|
| Scripts | Description | reference |
| [FQ invert] | Invert an element in [symbol] _{q}. | |
| [FQ2 invert] | Invert an element in [symbol] _{q}². | Table 5 |
| [FQ6 invert] | Invert an element in [symbol] _{q}⁶. | Table 8 |
| [FQ12Quadratic invert] | Invert an element in [symbol] _{q}¹². | Table 9 |
| [FQ12Quadratic | Invert a unitary element in | |
| conjugate] | [symbol] _{q}¹². | |

### 3.1.8 FQ12Frobenius

Exponentiation of an [symbol] _{q}_{¹²} element to the powers q, q², q³ using Frobenius.

TABLE 25
Exponentiation via Frobenius

| | | Pseudocode |
|---|---|---|
| Scripts | Description | reference |
| [q-Frobenius] | Exponentiate an element | Table 16 |
| | in [symbol] _{q}¹² to q. | |
| [q²-Frobenius] | Exponentiate an element | |
| | in [symbol] _{q}¹² to q². | |
| [q³ -Frobenius] | Exponentiate an element | |
| | in [symbol] _{q}¹² to q³. | |

### 3.2 Miller Loop Script

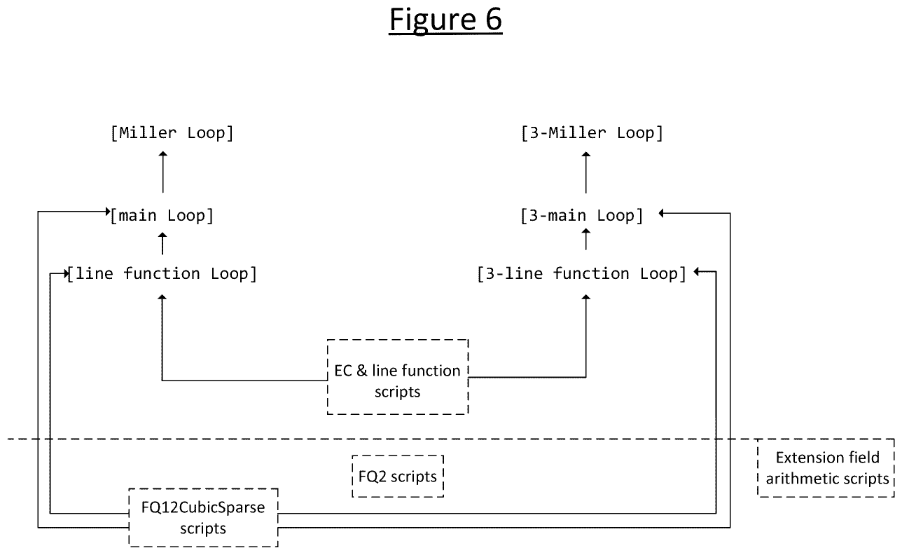

FIG. 6 shows the relationships of the scripts needed to implement the Miller loop for single pairing, or three pairings combined.

The Miller loop script comprises a line function and a square-and-update function. The output of the line function is an array of element, which are provided as input to the square-and-update function. The line function receives as inputs the curve points Q and P.

Each of these functions comprises multiple loops, the number of loops being defined by a curve parameter u, with the number of loops being equal to a bitlength of the curve parameter u. The curve parameter is hard-coded into the script, that is it is predefined. Each loops comprise a set of subfunctions for executing a portion of the function.

In both the single pairing and multi-pairing variations, each loop of the line function may comprise one of two different sets of subfunctions, referred to herein as a first set of subfunctions and a second set of subfunctions. Which of these two sets of subfunctions to be used in a particular loop is dependent on a curve parameter condition.

When the curve parameter is represented in a binary form, the curve parameter condition is based on a value of a corresponding bit of the curve parameter. In the examples below, a first curve parameter condition is met if the corresponding bit is set to 0, and a second curve parameter condition is met if the corresponding bit is set to 1.

If the corresponding bit of the curve parameter is set to 0, that is the first curve parameter is met, the first set of subfunctions is used. If instead the corresponding bit of the curve parameter is set to 1, that is the second curve parameter is met, the second set of subfunctions is used. Since the curve parameter is predefined and hard-coded in the script, the corresponding set of subfunctions for each loop of the line function is also predefined. There is, therefore, no need for branching in script.

In the case of a single pairing, the first set of subfunctions is a subset of the second set of subfunctions. That is, all subfunctions of the first set of subfunctions are also subfunctions of the second set of subfunctions.

In the case of a multi-pairing, the first and second set of subfunctions comprises some same subfunctions and some different subfunctions.

The array of element output by the line function comprises an element computed by, i.e. an output of, each loop of the line function.

The line function also includes an initial curve point subfunction, which takes as input the curve point Q and computes an initial curve point T. The first loop of the line function takes the initial curve point as input and update the curve point T. Each subsequent loop of the line function takes a current curve point T computed by a previous loop as input and is configured to update T to compute a next current curve point.

The element of the array of elements computed by a particular loop is computed based on the current curve point T, that is the curve point T received as input to said loop.

In the single pairing variation, the square-and-update function also comprises two sets of subfunctions, with the particular set used for each loops being dependent on the curve parameter conditions as set out above. The two possible sets of subfunctions of the square-and-update function may be referred to herein as a third and fourth set of subfunctions.

Each of the third and fourth set of subfunctions comprise a squaring subfunction and a multiplication subfunction. In the third set of subfunctions, the multiplication subfunction is a sparse-by-dense vector multiplication, whereas in the fourth set of subfunctions, the multiplication subfunction is a somewhat-sparse-by-dense vector multiplication.

In the multi-pairing variation, the loops of the square-and-update function comprise the same set of subfunctions irrespective of the curve parameter u. All loops comprise the same squaring subfunction and multiplication subfunction.

The output of the square-and-update function is an intermediate value ƒ. The intermediate value ƒ can be used to compute a pairing.

The scripts which may be used to execute a Miller loop for single or multi pairings are shown in Tables 26 and 27 respectively.

By executing the Miller loop in this way, the intermediate value can be computed via sparse multiplication in the extension field. The operands of sparse multiplications can be described very succinctly, which reduces the number of opcodes for stack management, and therefore improves efficiency of computation. Novel formulas for different variations of sparse multiplications are set out fully in Table 11.

As the curve parameter is predefined, each loop of each function is predefined. The term loop, therefore, refers to a set of subfunctions within the function which are implemented sequentially. The loops may be considered to be unrolled. That is, a specific set of subfunctions is not executed again with different inputs, but rather an identical set of subfunctions, or a similar set of subfunctions in the event that curve parameter conditions is different, is executed using inputs from a directly previous set of subfunctions.

In this way, the Miller loop itself can be considered to be unrolled. That is, each subfunction is executed only once.

### 3.2.1 Breaking the Miller Loop in Two Loops

To iterate over the Miller loop, the Miller loop (Table 2, steps 1-10) is broken into two loops. The first loop calculates and storesthe results of the line function evaluations in an array g of FQ12 elements. The main (second) loop takes as input the stored results g and updates and squares the element ƒ.

[Miller loop]:=[Line functions loop][Main loop]

By computing the Miller loop in this way, many multiplications are sparse, which are faster to describe (and execute) than standard FQ12 multiplication in script. See Table 26 for the pseudocode.

### 3.2.2 Multi-Pairings

A combined Miller loop can also be implemented which enables support for multi-pairings. The case of three pairings is provided herein. In this case, three line functions (one for each pairing) are calculated together resulting in an array g holding the combined line functions calculations. Then, update and square the combined ƒ value.

[3-miller loop]:=[3-line functions loop][3-main loop]

Combining the line functions together allows to do more sparse multiplications overall than if they are calculated separately, therefore, increasing the speed of computation. See Table 27 for the pseudocode.

### 3.2.3 Precomputing λ, θ for Adding Points and Point Addition Function

In the formula to calculate the point addition function (Table 14), the values λ and θ are the same as for point addition T+Q (Table 13, top). In the Miller loop, these values only need to be computed once for both operations. Therefore, λ, θ can be computed first and equivalent routines defined for point addition and line evaluation, respectively, that take λ and θ as input.

TABLE 26
Miller loop (see Table 2, steps 1-10) expressed as two loops and with sparse multiplication

```
Script [Line functions loop] // curve parameter u hard-coded
Input: Q := (x̅, y̅) ∈ E′( [symbol] _{q2}), P := (x_{P}, y_{P}) ∈ E( [symbol] _{q})
Output: An array g of └log(u)┘ FQ12 elements.
    If i-th bit uᵢ = 0, then gᵢ = (āᵢ, b̅ᵢ, c̅ᵢ) // Sparse FQ12Cubic element
    Else if uᵢ = 0 then gᵢ = (āᵢ, b̅ᵢ, c̅ᵢ, d̅ᵢ, ēᵢ) // Somewhat-sparse FQ12Cubic element
Steps:
```

| | |
|---|---|
| 1. | T := (x, y, (1, 0)) // Set Q in projective coordinates |
| 2. | // For i := └log(u)┘ − 1 down to 0 do (unrolled loop: fixed u): |
| 3. | [Point doubling line] // gᵢ := g_{Ψ(T),Ψ(T)}(P) // Sparse |
| 4. | [Double point] // T := [2]T |
| 5. | // If uᵢ = 1 then: // Branchless If (fixed uᵢ) |
| 6. | [Compute and 0] // Precompute λ, θ |
| 7. | [Point addition line with input λ, θ] // t′ᵢ := g_{Ψ(T),Ψ(Q)}(P) // Sparse |
| 8. | $[ FQ 12 Cubic sparse by sparse mult ] // {g}_{i} := {g}_{i} \cdot {t}_{i}^{′} // Somewhat - sparse$ |
| 9. | [Add points with input λ, θ] // T := T + Q |
| 10. | // End if |
| 11. | // End for |

```
Script [Main loop] // curve parameter u hard-coded
Input: An array g of └log(u)┘ FQ12 elements (from [Line functions loop] output above).
    If i-th bit uᵢ = 0, then gᵢ = (āᵢ, b̅ᵢ, c̅ᵢ) // Sparse FQ12Cubic element
    Else if uᵢ = 0 then gᵢ = (āᵢ, b̅ᵢ, c̅ᵢ, d̅ᵢ, ēᵢ) // Somewhat-sparse FQ12Cubic element
Output: f := (x̅₀, x̅₁, x̅₂) := ((ā, b̅), (c̅, d̅), (ē, f̅)) // FQ12Cubic dense element
Steps:
```

| | |
|---|---|
| 1. | f := g[└log(u)┘ − 1] // Set initial value of f (First iteration of Miller loop) |
| 2. | // For i := └log(u)┘ − 2 down to 0 do (unrolled loop: fixed u): |
| 3. | [FQ12Cubic square] // f := f² |
| 4. | // If uᵢ = 0 then g[i] is a sparse FQ12 element // Branchless If (fixed uᵢ). |
| 5. | [FQ12Cubic sparse by dense mult] // f := gᵢ · f |
| 6. | // Else uᵢ = 1 and g[i] is somewhat-sparse |
| 7. | [FQ12Cubic somewhat-sparse by dense mult] // f := gᵢ · f |
| 8. | // End If |
| 9. | // End for |

TABLE 27
Combined Miller loop for three pairings with sparse multiplication

Script [3-line functions loop] // curve parameter u hard-coded
Input: Qⱼ == ((x̅ⱼ, y̅ⱼ) ∈ E′ ( [symbol] _{q2}), Pⱼ := (x_{P}_{ⱼ}, y_{P}_{ⱼ}) ∈ E( [symbol] _{q}) for j = 1, 2, 3.
Output: An array g of └log(u)┘ FQ12Cubic dense elements.
Steps:

| | |
|---|---|
| 1. | Tⱼ := (x̅ⱼ, y̅ⱼ, (1, 0)) // Set Qⱼ in projective coordinates for j = 1, 2, 3 |
| 2. | // For i := └log(u)┘ − 1 down to 0 do (unrolled loop: fixed u): |
| 3. | [Point doubling line]// t_{i,j} := g_{Ψ(T}_{ⱼ}_{),Ψ(T}_{ⱼ}₎(Pⱼ) for j = 1, 2, 3 (Sparse) |
| 4. | [Double point] // Tⱼ := [2]Tⱼ for j = 1, 2, 3 |
| 5. | // If uᵢ = 0 then: // Branchless If (fixed uᵢ) |
| 6. | [ FQ12Cubic sparse by sparse mult] // gᵢ := t_{i,1} · t_{i,2} (Somewhat-sparse) |
| 7. | [FQ12Cubic sparse by somewhat-sparse mult] // gᵢ := t_{i,3} . gᵢ. (Dense) |
| 8. | // If uᵢ = 1 then: |
| 9. | [Compute λⱼ and θⱼ] // Precompute λⱼ, θⱼ for j = 1, 2, 3 |
| 10. | [Point addition line with input λⱼ, θⱼ] // t′_{i,j} := g_{Ψ(T}_{ⱼ}_{),Ψ(Q}_{ⱼ}₎(Pⱼ) for j = 1, 2, 3 (Sparse) |
| 11. | $[ FQ 12 Cubic Sparse by sparse mult ] // {t}_{i , j} := {t}_{i , j} \cdot {t}_{i , j}^{′} for j = 1 , 2 , 3 ( Somewhat - sparse )$ |
| 12. | [FQ12Cubic somewhat-sparse by somewhat-sparse mult] // gᵢ := t_{i,1} · t_{i,2} (Dense) |
| 13. | [FQ12Cubic somewhat-sparse by dense] // gᵢ := t_{i,3} · gᵢ (Dense) |
| 14. | [Add points with input λⱼ, θⱼ] // Tⱼ := Tⱼ + Qⱼ for j = 1, 2, 3 |
| 15. | // End If |
| 16. | // End for |

Script [3-main loop] // curve parameter u hard-coded
Input: An array g of └log(u)┘ FQ12Cubic dense elements (from [Line functions loop]
output above).
Output: f := (x̅₀, x̅₁, x̅₂) := ((ā, b̅), (c̅, d̅), (ē, f̅)) // FQ12Cubic dense element
Steps:

| | |
|---|---|
| 1. | f := g_{└log(u)┘-1} // Set initial value of f (First iteration of Miller loop) |
| 2. | // For i := └log(u)┘ − 2 down to 0 do (unrolled loop: fixed u): |
| 3. | [FQ12Cubic square] // f := f² |
| 4. | [FQ12Cubic multiply] // f := f · gᵢ |
| 5. | // End for |

Script [3-Miller loop] // curve parameter u hard-coded
Input: Qⱼ = (x̅ⱼ, y̅ⱼ) ∈ E′ ( [symbol] _{q2}), Pⱼ := (x_{P}_{ⱼ}, y_{P}_{ⱼ}) ∈ E( [symbol] _{q}) for j = 1, 2, 3
Output: f = ((x̅₀, x̅₁, x̅₂) := ((ā, b̅), (c̅, d̅), (ē, f̅)) // FQ12Cubic dense element
Steps:

1. [3-line functions loop] // Calculate array g of line calculations
2. [3-main loop] // Update and square f

### 3.2.4 Scripts

The Miller loops has three types of operations: [symbol]
1) Point addition/point doubling in the twisted curve E′( [symbol] _{q}_{²}).
2) Line functions evaluations in the target field [symbol] _{q}_{¹²}.
3) Sparse multiplications and squaring in [symbol] _{q}_{¹²}.

Scripts for (3) have been covered in Section 3.1. The remaining scripts for implementing the Miller loop are listed in Table 28 and Table 29.

TABLE 28
Elliptic curve arithmetic and line function evaluation scripts

| Scripts | Description | Pseudocode reference |
|---|---|---|
| [Compute λ, θ] | Precompute λ, θ for point | Table 13 |
| | addition and line function. | |
| [Add points with inputs λ, θ] | Add points T + Q in | |
| | E′( [symbol] _{q}²). | |
| [Double point] | Double point [2]T in | |
| | E′( [symbol] _{q}²). | |
| [Point addition line with inputs | Compute g_{Ψ(T),Ψ(Q)}(P) in | Table 14 |
| λ, θ] | [symbol] _{q}¹². | |
| [Point doubling line] | Compute g_{Ψ(T),Ψ(T)}(P) in | Table 15 |
| | [symbol] _{q}¹². | |

TABLE 29
Miller loop scripts

| Scripts | Description | Pseudocode reference |
|---|---|---|
| [Line functions | Compute array g of line | Table 26 |
| loop] | functions evaluations. | |
| [Main loop] | Update and square f. | |
| [Miller loop] | Compute the Miller loop. | |
| [3-line functions | Compute array g for three | Table 27 |
| loop] | line functions evaluations | |
| | combined. | |
| [3-main loop] | Update and square f . | |
| [3-Miller loop] | Compute the combined | |
| | Miller loop for three | |
| | pairings | |

### 3.3 Final Exponentiation Scripts

### 3.3.1 Avoiding Inversion

The most expensive (field arithmetic) operation in the pairing calculation is computing an inverse in [symbol] _{q}_{¹²}. During the second part of the final exponentiation, inverses can be avoided via conjugation, but in the first part this is not possible. Therefore, the output ƒ of the Miller loop must be inverted to compute the pairing.

In the method described herein, ƒ is inverted off-chain and then the inversion ƒ′=ƒ⁻¹ is passed as an input to the final exponentiation script. Thus, the inversion routine is replaced by instead checking ƒ·ƒ′=1. This change results in a significant saving when describing the script, as all routines dedicated to inversions in the intermediate extension fields are not needed anymore. See Table 30.

TABLE 30
First part of the final exponentiation with inverse check.

```
Exponentiate easy part with inverse check:
Input:
    f := (x̅, y̅) ∈ [symbol] _{q12} := [symbol] _{q6}[w]/(w² − v) // Output of Miller loop
    f′ ∈ [symbol] _{q}_{¹²} := [symbol] _{q}_{⁶}[w]/ (w² − v) // The purported inverse of f
Output: g := (x̅′, y̅′) = f ^{(q}^{⁶}^{-1)(q}^{²}⁺¹⁾
```

| | |
|---|---|
| 1. | Assert f · f′ = 1 // All coefficients set to zero except constant |
| | coefficient x₀ := 1 |
| 2. | f₂ := \hat{f} = (x̅, −y̅) // Conjugate f |
| 3. | f₃ := f′ · f₂ |
| 4. | ${f}_{4} := {f}_{3}^{{q}^{2}} // {q}^{2} - Frobenius . See Table 16 , top right .$ |
| 5. | g := f₃ · f₄ |

Multiplication is carried over [symbol] _{q12} as a quadratic extension (see Table 9).

As above, the value ƒ may be referred to herein as the intermediate value. The inverse of this value, ƒ′ as provided as input to the final exponentiation script may be referred to herein as a candidate inverse intermediate value. The provided inverse is considered a candidate value since the step ƒ·ƒ′=1 checks that the provided inverse is the inverse of ƒ. This check has the effect of verifying that the target inverse intermediate value is equal to a target inverse intermediate value, with the target inverse intermediate value being the inverse of the value ƒ.

In one embodiment, the intermediate value ƒ is an output of the Miller loop script 404. The intermediate value ƒ can be considered to be derived from an initial value, as described later.

### 3.3.2 Composing First and Second Exponentiations

The final exponentiation script simply runs sequentially the easy and hard parts. Since there are two flavours for the easy part, there are two final exponentiation scripts.

[Final exponentiation]:=[Easy part][Hard part]

[Final exponentiation with inverse check]:=[Easy part with inverse check][Hard part]

### 3.3.3 Scripts

Table 31 lists the necessary scripts for the final exponentiation.

TABLE 31
Final exponentiation scripts

| | | Pseudocode |
|---|---|---|
| Scripts | Description | reference |
| [Conjugate] | Compute the inverse of a | Table 9, bottom right |
| | unitary element in [symbol] _{q12}. | |
| [Exponentiate to u] | Exponentiate a unitary element to | Table 10 |
| | the curve parameter u. The exponent | |
| | u is hard-coded in the script, and the | |
| | loop unrolled. | |
| $[ Exponentiate to \frac{u}{2} ]$ | $As above but with exponent \frac{u}{2} .$ | |
| [Easy part] | Compute f^{(q}^{⁶}^{-1)(q}^{²}⁺¹⁾, | Table 17 |
| | where f is the output of the | |
| | Miller loop. | |
| [Easy part with inverse check] | As above but without | Table 30 |
| | inverting f. (It takes extra | |
| | input f′ := f⁻¹) | |
| [Hard part] | $Compute {g}^{\frac{{q}^{4} - {q}^{2} + 1}{r}} , where g$ | Table 18 |
| | is the output of the easy part. | |
| [Final exponentiation] | Outputs the pairing | Concatenation of easy |
| | | and hard parts |
| [Final exponentiation with | Outputs the pairing | Concatenation of easy |
| inverse check] | | (with inverse check) |
| | | and hard parts |

### 3.4 Pairing Scripts

These scripts combine the Miller loop scripts with the final exponentiation scripts.

### 3.4.1 Switching Representations

The output of the Miller loop is an element ƒ in [symbol] _{q}_{¹²} as a cubic extension. The final exponentiation expects the same ƒ but represented as an element of the quadratic extension.

TABLE 32
Switching from cubic to quadratic representations. See also Table 3.

From cubic to quadratic
Input f := ((a, b), (c, d), (e, f)) ϵ [symbol] _{q}¹² := [symbol] _{q}⁴ [r]/(r³ − s )
Output f′ := ((a, e, d), (c, b, f) ) ϵ [symbol] _{q}¹² := [symbol] _{q}⁶[w]/ (w² − v)

### 3.4.2 Single Pairing Scripts

Two variations for the pairing script may be used. They are functionally equivalent, but the second one (with inverse check) is shorter to describe.

### Standard Pairing Script:

[Pairing]:=[Miller loop][From cubic to quadratic][Final exponentiation]

### Size-Efficient Pairing Script:

[Pairing with inverse check]:=[Miller loop][From cubic to quadratic][Final exponentiation with inverse check]

### 3.4.3 Multi-Pairing Scripts

Likewise, for multi-pairings, two variations of pairing scripts may be used, depending on whether or not inverses are computed off-chain and checked on-chain:

### Standard 3-Pairing Script:

[3-pairing]:=[3-Miller loop][From cubic to quadratic][Final exponentiation]

### Size-Efficient 3-Pairing Script:

[3-pairing with inverse check]:=[3-Miller loop][From cubic to quadratic][Final exponentiation with inverse check]

### 4 Blockchain Implementations

The scripts above may be used in blockchain transactions. The example provided herein uses the use case of providing knowledge of a secrete value, e.g. a zero-knowledge proof. It will be appreciated that the pairing generated by executing the scripts may be used for other purposes as known in the art by modifying the locking script to execute the required computations.

Alice, a challenger, generates a locking, or challenge, blockchain transaction. The locking blockchain transaction comprises a locking script, which causes the computations and verifications discussed above to be executed, and a pairing computed.

Bob, a challengee, generates an unlocking blockchain transaction. The unlocking transaction may be referred to as a solution or proof blockchain transaction. Bob may also be referred to herein as a provider or a proof generator. The unlocking transaction comprises an unlocking script which provides the inputs required for satisfying the requirements of the locking script and generating the pairing.

For example, Alice generates a locking script which locks an amount of UTXO. The locking script is unlocked by a locking script which proves knowledge of the secret value using a zero-knowledge proof. To verify the zero-knowledge proof, a bilinear pairing is computed.

The locking script of the present example computes the pairing using each script 402, 404, 406, 408 of FIG. 4. However, it will be appreciated that any combination of these scripts may be used together with other suitable script blocks to compute the pairing. For example, the Miller loop script 404 may be used together with a known script for computing an inverse, and the output of these two scripts used to compute the pairing.

The unlocking script generated by Bob and included in the proof transaction comprises all elements required, by the locking script, to compute the pairing, as well as any other components required to satisfy the requirements of the locking script.

In this example, the unlocking script comprises a candidate proof value, also referred to as an initial value, and a candidate inverse intermediate value. The initial value comprises points P,Q in the source groups used for computing the pairing. The candidate inverse intermediate value is a point in the target field (an element of field FQ12). The unlocking script also comprises a signature generated using Bob's private key.

The locking script comprises the Miller loop script 404, configured to execute the line function and square-and-update function as described above. The Miller loop script 404 derives the intermediate value ƒ as set out above, based on the proof provided in the unlocking script.

The locking script also comprises the final exponentiation script 406, configured to check that the candidate inverse intermediate value ƒ′ provided in the unlocking script is equal to the inverse of the intermediate value ƒ computed by the Miller loop script 404. This check can be achieved as set out above.

The locking script also comprises the bilinear pairing script 408, configured to compute the pairing. This takes as input the intermediate value ƒ computed by the Miller loop script 404 and the candidate inverse intermediate value ƒ′ provided in the unlocking script.

The locking script may comprise a further computational block or script configured to verify the proof provided in the unlocking script based on the computed bilinear pairing.

The locking script may be considered to provide a request for the values required for unlocking the UTXO, such as the candidate inverse intermediate value. In some embodiments, the challenger may send a request off-chain for the inclusion of the required values in the unlocking script.

It will be appreciated that the term “proof” is not limited to a zero-knowledge proof. The proof may instead be some value which proves eligibility for partaking in an exchange, for example.

The initial value, or proof, provided in the unlocking script comprises a pair of elliptic curve points from which the bilinear pairing can be computed. Alternatively, the pair of elliptic curve point may be derived from the initial value.

The locking script of the blockchain transaction may be used for other computations using the pairing. For example, a BLS signature may be computed using the result of the pairing.

The initial value, provided in the unlocking script, may comprise the public key and the message (points P,Q for which the pairing is computed), or the signature and the curve generator (also seen as P,Q for a second pairing evaluation).

The skilled person would be aware of other computations which use bilinear pairings, and which may be implemented using the methods disclosed herein. In each implementation, the initial value is points P,Q over which the pairing is computed. What these points mean depends on use case: a proof in zk-proofs, signature/public key in signatures etc. as discussed herein.

### 5 Examples

### 5.1 Script Size Estimation

The input is 6 elements in [symbol] _{q}, representing two points P and Q. That is, roughly 6×50=300 bytes.

TABLE 33

| Line Functions | Estimation | Number | |
|---|---|---|---|
| Loop | (bytes) | of loops | Total |
| [Point doubling | 50 | 65 | 3250 |
| line] | | | |
| [Double point] | 120 | 65 | 7800 |
| [Compute λ and θ] | 24 | 5 | 120 |
| [Point addition line | 70 | 5 | 350 |
| with input λ and θ] | | | |
| [FQ12Cubic sparse | 90 | 5 | 450 |
| by sparse mult] | | | |
| [Add points with | 170 | 5 | 850 |
| input λ and θ] | | | |
| | | | 12820 |

TABLE 34

| Main Loop | Estimation (bytes) | Number of loops | Total |
|---|---|---|---|
| [FQ12Cubic | 70 | 65 | 4550 |
| Square] | | | |
| [FQ12Cubic sparse | 190 | 60 | 11400 |
| by dense mult] | | | |
| [FQ12Cubic | 330 | 5 | 1650 |
| somewhat-sparse | | | |
| by dense mult] | | | |
| | | | 17600 |

TABLE 35

| Exponentiate easy | | | |
|---|---|---|---|
| part with inverse | Estimation | Number | |
| check | (bytes) | of times | Total |
| Assert correctness | 370 | 1 | 370 |
| of inverse | | | |
| [FQ12 dense by | 350 | 2 | 700 |
| dense with FQ6- | | | |
| tower] | | | |
| Q2 Frobenius | 300 | 1 | 300 |
| Conjugate | 30 | 1 | 30 |
| | | | 1400 |

TABLE 36

| Exponentiate hard | Estimation | | |
|---|---|---|---|
| part | (bytes) | Number of times | Total |
| Squaring | 240 | 1 + 65 + 64 + | 78000 |
| | | 65 + 65 + 65 | |
| multiplication | 350 | 4 × 5 + 8 | 9800 |
| Q2 Frobenius | 300 | 1 | 300 |
| Q Frobenius | 300 | 1 | 300 |
| Q3 Frobenius | 300 | 1 | 300 |
| Conjugate | 30 | 4 | 120 |
| | | | 88820 |

As a estimation, the script size is roughly 121 KB for evaluation of one pairing in script.

If three pairing evaluation is required and check for equality, then the script size is roughly 180 KB (30 KB for one Miller loop, hence 90 KB for three Miller loops, and one final exponentiation of 90 KB). The current smallest script for such comparison is 1.5 MB claimed by sCrypt. Even with some stack position management, the script size for three pairing evaluation and equality verification provided herein is significantly less than 1.5 MB.

It is noted that the [3-Miller Loop] script set out above provides further script size savings.

### 5.2 BLS12

Parameters in hexadecimal.

q:
0x1a0111ea397fe69a4b1ba7b6434bacd764774b84f38512bf6730d2a0f6b0f6241eabf
ffeb153ffffb9feffffffffaaab
r:
0x73eda753299d7d483339d80809a1d80553bda402fffe5bfeffffffff00000001
x:
0x17f1d3a73197d7942695638c4fa9ac0fc3688c4f9774b905a14e3a3f171bac586c55e
83ff97a1aeffb3af00adb22c6bb
y:
0x08b3f481e3aaa0f1a09e30ed741d8ae4fcf5e095d5d00af600db18cb2c04b3edd03cc
744a2888ae40caa232946c5e7e1
h:
0x396c8c005555e1568c00aaab0000aaab
b: 4
x′_0:
0x024aa2b2f08f0a91260805272dc51051c6e47ad4fa403b02b4510b647ae3d1770bac
0326a805bbefd48056c8c121bdb8
x′_1:
0x13e02b6052719f607dacd3a088274f65596bd0d09920b61ab5da61bbdc7f5049334
cf11213945d57e5ac7d055d042b7e
y′_0:
0x0ce5d527727d6e118cc9cdc6da2e351aadfd9baa8cbdd3a76d429a695160d12c923a
c9cc3baca289e193548608b82801
y′_1:
0x0606c4a02ea734cc32acd2b02bc28b99cb3e287e85a763af267492ab572e99ab3f37
0d275cec1da1aaa9075ff05f79be
h′:
0x5d543a95414e7f1091d50792876a202cd91de4547085abaa68a205b2e5a7ddfa628
f1cb4d9e82ef21537e293a6691ae1616ec6e786f0c70cf1c38e31c7238e5
b′: 4 * (u + 1)

### 6. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 7. UTXO-Based Model

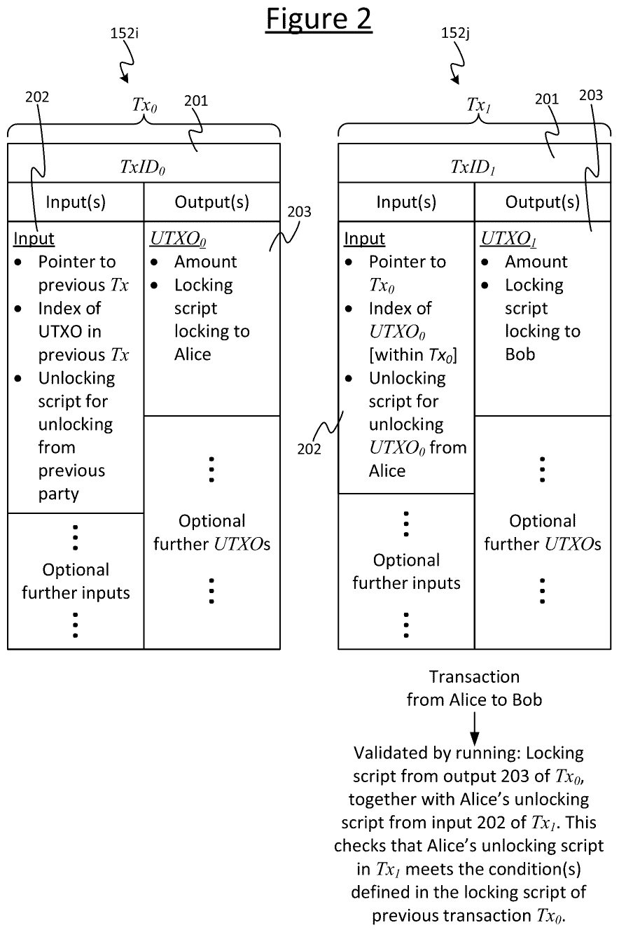

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Txₗ are just arbitrary labels. They do not necessarily mean that Tx₀ is the first transaction in the blockchain 151, nor that Txₗ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, Tx/Do, which in embodiments is the hash of the whole transaction Tx₀). The input 202 of Txₗ comprises an index identifying UTXO₀ within Tx₀, to identify it amongst any other possible outputs of Tx₀. The input 202 of Txₗ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 8. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method for computing a pairing in script, the method comprising generating a script configured to: execute a line function to compute an array of elements; and execute a square-and-update function, wherein the array of elements is provided as an input to the square-and-update function, to compute an intermediate value for computing a pairing.

Statement 2. The method of statement 1 wherein the line function comprises a plurality of loops, wherein each loop comprises one of a first set of subfunctions or a second set of subfunction, wherein the set of subfunctions of a specific loop is predefined, wherein the number of loops of the line function is predefined, wherein each loop of the line function is configured to: compute a portion of the array of elements; and update a current curve point; wherein each loop of the line function receives as input the current curve point computed by a previous loop of the line function except a first loop of the line function.

Statement 3. The method of statement 2, wherein the line function further comprises: an initial curve point subfunction configured to compute an initial current curve value; wherein the initial current curve value is provided as input to the first loop of the line function.

Statement 4. The method of statement 2 or statement 3, wherein each of the plurality of loops of the line function further comprises a point doubling line subfunction configured to compute a sparse array of elements based on the current curve point, wherein the array of elements output by the line function is based at least in part on the sparse array of elements.

Statement 5. The method of any of statements 2 to 4, wherein each of the plurality of loops of the line function further comprises a point doubling subfunction configured to double a current curve point.

Statement 6. The method of statement 2 or any statement dependent thereon, wherein the number of loops of the line function is dependent on a predefined curve parameter.

Statement 7. The method of statement 6, wherein the predefined curve parameter is represented in a binary format, wherein each loop of the plurality of loops of the line function corresponds to a bit of the curve parameter, wherein: if a first curve parameter condition is met, the corresponding loop of the line function comprises the first set of subfunctions; and if a second curve parameter condition is met, the corresponding loop of the line function comprises the second set of subfunctions.

Statement 8. The method of statement 5 or any statement dependent thereon, wherein the second set of subfunctions further comprises at least one sparse vector multiplication subfunction, wherein an output of the at least one sparse vector multiplication is a somewhat sparse vector.

Statement 9. The method of statement 8, wherein the second set of subfunctions further comprises a point addition line subfunction, wherein an output of the point addition line subfunction is sparse and provided as input to the sparse vector multiplication subfunction.

Statement 10. The method of statement 9, wherein the point addition line subfunction has inputs λ and θ, wherein the second set of subfunctions of the line function further comprises: a precompute subscript for computing λ and θ; and a point addition subfunction configured to update the current curve point, wherein λ and θ are inputs for the point addition subfunction.

Statement 11. The method of statement 9 or statement 10, wherein the sparse vector multiplication subfunction comprises two inputs, wherein the inputs of the sparse vector multiplication subfunction comprise: the output of the point addition line subfunction; and an output of the point doubling line subfunction.

Statement 12. The method of statement 11, wherein the portion of the array of elements computed by each loop of the line function comprises: if the loop comprises the first set of subfunctions, the output of the point doubling line subfunction of each of the plurality of sets of subfunctions; and if the loop comprises the second set of subfunctions, an output of the sparse vector multiplication subfunction of each of the plurality of sets of subfunctions.

Statement 13. The method of statement 11, wherein the second set of subfunctions of the line function further comprises: a somewhat-sparse vector multiplication subfunction, having inputs of a first and second vector output of the sparse vector multiplication subfunction; and a second somewhat-sparse vector multiplication subfunction, having inputs of a third vector output of the sparse vector multiplication subfunction and an output of the somewhat-sparse vector multiplication subfunction; wherein the portion of the array of elements computed by a loop of the line function comprising the second set of subfunctions comprises an output of the second somewhat-sparse vector multiplication subfunction.

Statement 14. The method of any of statements 4 to 11, or statement 13, wherein first set of subfunctions of the line function further comprises: a second sparse vector multiplication subfunction having inputs of a first and second vector output of the point doubling line subfunction; and a second somewhat-sparse vector multiplication subfunction having inputs of a third vector output of the point doubling line subfunction and an output of the second sparse vector multiplication subfunction; wherein the portion of the array of elements computed by a loop of the line function comprising the first set of subfunctions comprises an output of the second somewhat-sparse vector multiplication subfunction.

Statement 15. The method of any preceding statement, wherein the square-and-update function comprises a plurality of loops, wherein each loop of the square-and-update function comprises a set of subfunctions, wherein the number of loops of the square-and-update function is predefined, wherein each loop of the square-and-update function is configured to update a current intermediate value, wherein each loop of the square-and-update function receives as input the current intermediate value computed by a previous loop of the square-and-update function except a first loop of the square-and-update function, wherein the square-and-update function further comprises: an initial intermediate value subfunction configured to compute a first current intermediate value based on the array of elements output by the line function; wherein the first current intermediate value is provided as input to the first loop of the square-and-update function.

Statement 16. The method of statement 15, wherein each loop of the square-and-update function comprises: a squaring subfunction configured to compute a square of the current intermediate value; and a multiply subfunction configured to multiply the square of the current intermediate value with the array of elements to update the current intermediate value.

Statement 17. The method of statement 15 or statement 16, wherein the number of loops of the square-and-update function is dependent on a curve parameter.

Statement 18. The method of any of statements 15 to 17, wherein the output of a final loops of the square-and-update function is the intermediate value for computing a pairing.

Statement 19. The method of any of statements 16 to 18, wherein each loop of the square-and-update function comprises one of a third set of subfunctions and a fourth set of subfunctions, wherein the set of subfunctions of a specific loop is predefined, wherein: the multiple subfunction of the third set of subfunctions is a sparse-by-dense multiplication; and the multiplication subfunction of the fourth set of subfunctions is a somewhat sparse-by-dense multiplication.

Statement 20. The method of statement 19, wherein the number of loops of the square-and-update function is dependent on a predefined curve parameter.

Statement 21. The method of statement 20, wherein the predefined curve parameter is represented in a binary format, wherein each loop of the plurality of loops of the line function corresponds to a bit of the curve parameter, wherein: if a first curve parameter condition is met, the corresponding loop of the square-and-update function comprises the third set of subfunctions; and if a second curve parameter condition is met, the corresponding loop of the square-and-update function comprises the fourth set of subfunctions.

Statement 22. The method of statement 7 or statement 21, wherein the predefined curve parameter is represented in a binary format, wherein: the first curve parameter condition is met if an i^{th} bit of the predefined curve parameter is set to zero; and the first curve parameter condition is met if an i^{th} bit of the predefined curve parameter is set to one.

Statement 23. The method of any preceding statement, wherein the script is further configured to execute a pairing computation to compute a pairing based on the intermediate value output by the square-and-update function.

Statement 24. The method of any preceding statement, wherein the script is further configured to: receive, from a proving entity, a candidate inverse intermediate value; determine if the candidate inverse intermediate value is equal to a target intermediate inverse value, wherein the target intermediate inverse value is an inverse of the computed intermediate value; wherein the pairing is computed if it is determined that the candidate inverse intermediate value is equal to the target intermediate inverse value.

Statement 25. The method of statement 5 or statement 7, wherein the point addition subfunction or point doubling function is an operation is a twisted curve.

Statement 26. The method of statement 4 or statement 9, wherein the point addition line subfunction or point doubling line function is an operation is a target field.

Statement 27. The method of any preceding statement, wherein the script is a blockchain script, wherein the method further comprises: generating a challenge blockchain transaction, wherein the challenge blockchain transaction comprises a first locking script comprising the script; and making the challenge blockchain transaction available to one or more nodes of a blockchain network.

Statement 28. Computer equipment comprising: memory comprising one or more memory units; and processing apparatus comprising one or more processing units, wherein the memory stores code arranged to run on the processing apparatus, the code being configured so as when on the processing apparatus to perform the method of any of statements 1 to 27.

Statement 29. A computer program embodied on computer-readable storage and configured so as, when run on one or more processors, to perform the method of any of statements 1 to 27.

1. A computer-implemented method for computing a pairing in script, the method comprising generating a script configured to:
execute a line function to compute an array of elements; and
execute a square-and-update function, wherein the array of elements is provided as an input to the square-and-update function, to compute an intermediate value for computing a pairing.

2. The method of claim 1 wherein the line function comprises a plurality of loops, wherein each loop comprises one of a first set of subfunctions or a second set of subfunction, wherein the set of subfunctions of a specific loop is predefined, wherein a number of loops of the line function is predefined, wherein each loop of the line function is configured to:
compute a portion of the array of elements; and
update a current curve point;
wherein each loop of the line function receives as input the current curve point computed by a previous loop of the line function except a first loop of the line function.

3. The method of claim 2, wherein the line function further comprises:
an initial curve point subfunction configured to compute an initial current curve value;
wherein the initial current curve value is provided as input to the first loop of the line function.

4. The method of claim 2, wherein each of the plurality of loops of the line function further comprises a point doubling line subfunction configured to compute a sparse array of elements based on the current curve point, wherein the array of elements output by the line function is based at least in part on the sparse array of elements.

5. The method of claim 2, wherein each of the plurality of loops of the line function further comprises a point doubling subfunction configured to double a current curve point.

6. The method of claim 2, wherein the number of loops of the line function is dependent on a predefined curve parameter.

7. The method of claim 6, wherein the predefined curve parameter is represented in a binary format, wherein each loop of the plurality of loops of the line function corresponds to a bit of the curve parameter, wherein:
if a first curve parameter condition is met, the corresponding loop of the line function comprises the first set of subfunctions; and
if a second curve parameter condition is met, the corresponding loop of the line function comprises the second set of subfunctions.

8. The method of claim 5, wherein the second set of subfunctions further comprises at least one sparse vector multiplication subfunction, wherein an output of the at least one sparse vector multiplication is a somewhat sparse vector.

9. The method of claim 8, wherein the second set of subfunctions further comprises a point addition line subfunction, wherein an output of the point addition line subfunction is sparse and provided as input to the sparse vector multiplication subfunction.

10. The method of claim 9, wherein the point addition line subfunction has inputs λ and θ, wherein the second set of subfunctions of the line function further comprises:
a precompute subscript for computing λ and θ; and
a point addition subfunction configured to update the current curve point, wherein λ and θ are inputs for the point addition subfunction.

11. The method of claim 9, wherein the sparse vector multiplication subfunction comprises two inputs, wherein the inputs of the sparse vector multiplication subfunction comprise:
the output of the point addition line subfunction; and
an output of the point doubling line subfunction.

12-14. (canceled)

15. The method of claim 1 wherein the square-and-update function comprises a plurality of loops, wherein each loop of the square-and-update function comprises a set of subfunctions, wherein a number of loops of the square-and-update function is predefined, wherein each loop of the square-and-update function is configured to update a current intermediate value, wherein each loop of the square-and-update function receives as input the current intermediate value computed by a previous loop of the square-and-update function except a first loop of the square-and-update function, wherein the square-and-update function further comprises:
an initial intermediate value subfunction configured to compute a first current intermediate value based on the array of elements output by the line function;
wherein the first current intermediate value is provided as input to the first loop of the square-and-update function.

16. The method of claim 15, wherein each loop of the square-and-update function comprises:
a squaring subfunction configured to compute a square of the current intermediate value; and
a multiply subfunction configured to multiply the square of the current intermediate value with the array of elements to update the current intermediate value.

17. The method of claim 15, wherein the number of loops of the square-and-update function is dependent on a curve parameter.

18. (canceled)

19. The method of claim 16, wherein each loop of the square-and-update function comprises one of a third set of subfunctions and a fourth set of subfunctions, wherein the set of subfunctions of a specific loop is predefined, wherein:
a multiple subfunction of the third set of subfunctions is a sparse-by-dense multiplication; and
the multiplication subfunction of the fourth set of subfunctions is a somewhat sparse-by-dense multiplication.

20. The method of claim 19, wherein the number of loops of the square-and-update function is dependent on a predefined curve parameter.

21. The method of claim 20, wherein the predefined curve parameter is represented in a binary format, wherein each loop of the plurality of loops of the line function corresponds to a bit of the curve parameter, wherein:
if a first curve parameter condition is met, the corresponding loop of the square-and-update function comprises the third set of subfunctions; and
if a second curve parameter condition is met, the corresponding loop of the square-and-update function comprises the fourth set of subfunctions.

22-26. (canceled)

27. The method of claim 1, wherein the script is a blockchain script, wherein the method further comprises:
generating a challenge blockchain transaction, wherein the challenge blockchain transaction comprises a first locking script comprising the script; and
making the challenge blockchain transaction available to one or more nodes of a blockchain network.

28. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method for computing a pairing in script, the method comprising generating a script configured to:
execute a line function to compute an array of elements; and
execute a square-and-update function, wherein the array of elements is provided as an input to the square-and-update function, to compute an intermediate value for computing a pairing.

29. A computer program embodied on non-transitory computer-readable storage media and configured so as, when run on one or more processors, the one or more processors perform a method for computing a pairing in script, the method comprising generating a script configured to:
execute a line function to compute an array of elements; and
execute a square-and-update function, wherein the array of elements is provided as an input to the square-and-update function, to compute an intermediate value for computing a pairing.
